(19) United States
(12) Patent Application Publication
(10) Pub. No.: US 2013/0282979 A1
(43) Pub. Date: Oct. 24, 2013

(54) STORAGE SYSTEM AND STORAGE VIRTUALIZATION METHOD

(71) Applicant: Toru Suzuki, Odawara (JP)

(72) Inventor: Toru Suzuki, Odawara (JP)

(21) Appl. No.: 13/508,886

(22) PCT Filed: Apr. 23, 2012
(86) PCT No.: PCT/JP12/02779

§ 371 Date: May 9, 2012

(51) Int. Cl. G06F 12/00

(52) U.S. Cl. 711/114; 711/E12.001

(57) ABSTRACT

A storage system comprises multiple primary storage apparatuses each comprising multiple primary logical volumes, which constitute the basis of a primary virtual volume, and multiple secondary storage apparatuses each comprising multiple secondary logical volumes, which constitute the basis of a secondary virtual volume forming a remote copy pair with the primary virtual volume, wherein the primary storage apparatus remote-copies data written in a primary logical volume of the relevant primary storage apparatus to a secondary logical volume of any secondary storage apparatus of the multiple secondary storage apparatuses corresponding to the write destination of this data.

### TECHNICAL FIELD

The present invention relates to storage virtualization technology.

### BACKGROUND ART

For example, government organizations, corporate entities and educational institutions handle huge volumes of data, and as a result use relatively large-scale storage systems to manage this data. These storage systems comprise at least one storage control apparatus. The storage control apparatus, for example, comprises a large number of storage devices, and is able to provide a storage area based on RAID (Redundant Array of Inexpensive Disks). At least one or more logical volumes are formed on top of the physical storage area provided by a group of storage devices. A host computer (hereinafter referred to as “host”) writes data to and reads data from a logical volume in accordance with issuing a “write” command or a “read” command.

For example, in the prior art, there is a storage system, which remote copies data stored in a virtual storage comprising multiple logical volumes of respective multiple storage devices to another logical volume of a different storage device (Patent Literature 1).

### CITATION LIST

### Patent Literature

PTL 1: Japanese Patent Application Laid-open No. 2009-93316

### SUMMARY OF INVENTION

### Technical Problem

The prior art storage system alleviates the concentration of access load for a prescribed storage apparatus in the source storage apparatus of remote copy-target data and in another storage apparatus, which is the destination of the remote copy-target data.

### Solution to Problem

A storage system comprises multiple primary storage apparatuses each comprising multiple primary logical volumes, which constitute the basis for a primary virtual volume, and multiple secondary storage apparatuses each comprising multiple secondary logical volumes, which constitute the basis for a secondary virtual volume forming a remote copy pair with the primary virtual volume. A primary storage apparatus remote copies data, which has been written to a primary logical volume of the relevant primary storage apparatus, to a secondary logical volume of any secondary storage apparatus of the multiple secondary storage apparatuses.

### BRIEF DESCRIPTION OF DRAWINGS

FIG. 1 is a diagram showing the system configuration of a storage system 1.

FIG. 2 is a schematic diagram for illustrating the relationship between a primary virtual VOL 12a and a second virtual VOL 12b, and respective logical VOLs 20.

FIG. 3 is a diagram showing the hardware configuration of a ST apparatus 10.

FIG. 4 is a diagram showing the functional configuration of the ST apparatus 10.

FIG. 5 is a diagram showing an example of the data configuration of a virtual VOL mapping information table 200.

FIG. 6 is a diagram showing an example of the data configuration of a virtual VOL configuration information table 210.

FIG. 7 is a diagram showing an example of the data configuration of a logical VOL information table 220.

FIG. 8 is a diagram showing an example of the data configuration of a pair management information table 230.

FIG. 9 is a diagram showing an example of the data configuration of a pair logical VOL information table 240.

FIG. 10 is a schematic diagram showing a concept of a “Freeze”.

FIG. 11 is a sequence chart showing an example of processing relative to a “write” command.

FIG. 12 is a sequence chart showing an example of RCP processing of a first ST apparatus 10a.

FIG. 13 is a sequence chart showing an example of the RCP processing of a second ST apparatus 10b.

FIG. 14 is a sequence chart showing an example of processing relative to a “read” command.

FIG. 15 is a sequence chart showing an example of processing relative to a “form pair” command.

FIG. 16 is a sequence chart showing an example of a pair formation preparation process.

FIG. 17 is a sequence chart showing an example of a pair formation copy process.

FIG. 18 is a sequence chart showing an example of a pair status 131 change process.

FIG. 19 is a sequence chart showing an example of processing relative to a “split pair” command.

FIG. 20 is a sequence chart showing an example of processing relative to a “resume pair” command.

FIG. 21 is a sequence chart showing an example of processing relative to a “delete pair” command.

FIG. 22 is a sequence chart showing an example of a failure suspend process.

FIG. 23 is a diagram showing the system configuration of a storage system related to Example 2.

FIG. 24 is a diagram showing the hardware configuration of a ST apparatus 10 related to Example 2.

FIG. 25 is a diagram showing an example of the data configuration of the virtual VOL mapping information table 200.

FIG. 26 is a diagram showing an example of the data configuration of the virtual VOL configuration information table 220.

FIG. 27 is a diagram showing an example of the data configuration of the logical VOL information table 220.

FIG. 28 is a diagram showing an example of the data configuration of the pair management information table 230.

FIG. 29 is a diagram showing an example of the data configuration of the pair logical VOL information table 240.

FIG. 30 is a schematic diagram for illustrating an inter-pair RCP in Example 2.

FIG. 31 is a sequence chart showing an example of the RCP processing of the second ST apparatus 10b.

FIG. 32 is a sequence chart showing an example of the processing in a case where a failure has occurred on the RCP path.

FIG. 33 is a diagram showing an example of the data configuration of a virtual apparatus information table 310.

FIG. 34 is a diagram showing an example of the data configuration of a ST apparatus information table 320.

FIG. 35 is a diagram showing an example of the data configuration of a communication path information table 330.

FIG. 36 is a flowchart showing an RCP pair formation process for a primary virtual VOL and a secondary virtual VOL.

### DESCRIPTION OF EMBODIMENTS

A number of examples will be explained below by referring to the drawings.

### Example 1

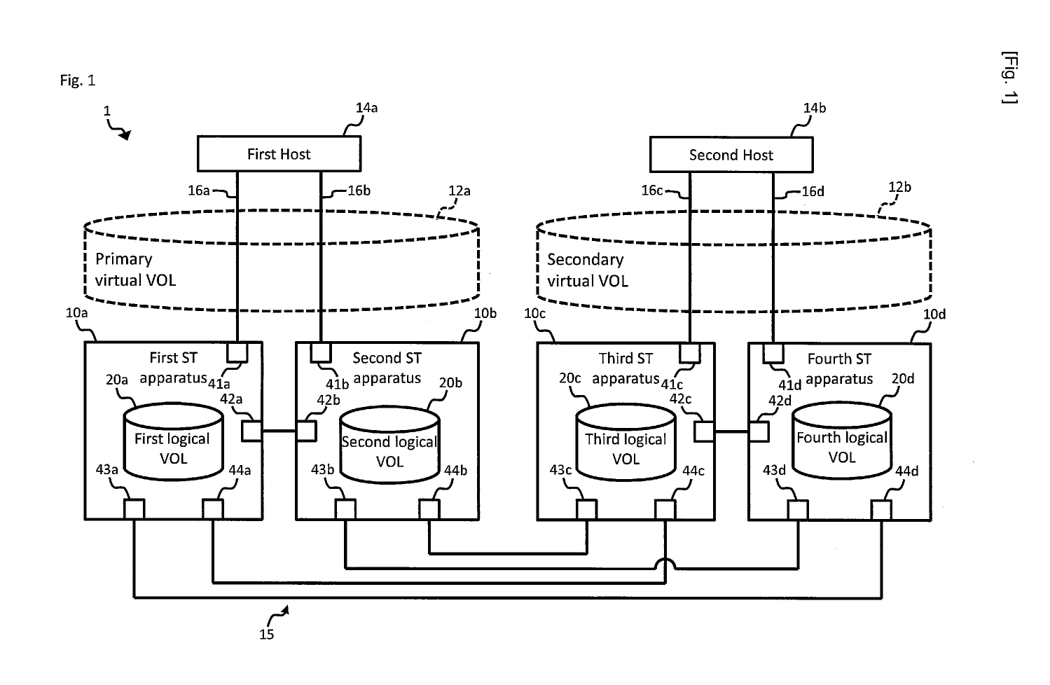

FIG. 1 is a diagram showing the system configuration of a storage system 1. The storage system 1 comprises a first storage (hereinafter referred to as “ST”) apparatus 10a, a second ST apparatus 10b, a third ST apparatus 10c, and a fourth ST apparatus 10d. The first ST apparatus 10a comprises a first logical VOL 20a, the second ST apparatus 10b comprises a second logical VOL 20b, the third ST apparatus 10c comprises a third logical VOL 20c, and the fourth ST apparatus 10d comprises a fourth logical VOL 20d. The logical VOL 20 will be explained in detail further below. Hereinafter, the first ST apparatus 10a through the fourth ST apparatus 10d may be collectively called the ST apparatus 10. The first logical VOL 20a through the fourth logical VOL 20d may be collectively called the logical VOL 20.

Each ST apparatus 10 is coupled to each other ST apparatus 10 via a cable 15, which enables two-way data communications. A first host 14a is coupled to the first ST apparatus 10a via a cable 16a, and is coupled to the second ST apparatus 10b via a cable 16b. The first host 14a is coupled to multiple ST apparatuses 10 to heighten fault tolerance by providing redundancy. Similarly, a second host 14b is coupled to the third ST apparatus 10c via a cable 16c, and is coupled to the fourth ST apparatus 10d via a cable 16d.

The first ST apparatus 10a and the second ST apparatus 10b provide the first host 14a with a primary virtual VOL 12a, which is a virtual storage. That is, the first host 14a apparatus treats the primary virtual VOL 12a as an ordinary ST apparatus, and can write and read data to/from this primary virtual VOL 12a. This primary virtual VOL 12a is configured from the first logical VOL 20a of the first ST apparatus 10a and the second logical VOL 20b of the second ST apparatus 10b. That is, in a case where the first host 14a executes a data write relative to the primary virtual VOL 12a, this data is actually written to the first logical VOL 20a and/or the second logical VOL 20b.

The third ST apparatus 10c and the fourth ST apparatus 10d also configure a secondary virtual VOL 12b from the third logical VOL 20c of the third ST apparatus 10c and the fourth logical VOL 20d of the fourth ST apparatus 10d.

In this storage system 1, the primary virtual VOL 12a and the secondary virtual VOL 12b comprise a pair, and data written to the primary virtual VOL 12a is remote copied (hereinafter referred to as “RCP (Remote Copy)”) to the secondary virtual VOL 12b. That is, in the storage system 1, the data stored in the primary virtual VOL 12a and the secondary virtual VOL 12b is synchronized. In a case where an access is generated from the second host 14b, the primary virtual VOL 12a and the secondary virtual VOL 12b may be reversed. Next, the relationship between the primary virtual VOL 12a and the secondary virtual VOL 12b and the respective logical VOLs 20 will be further explained using the drawings.

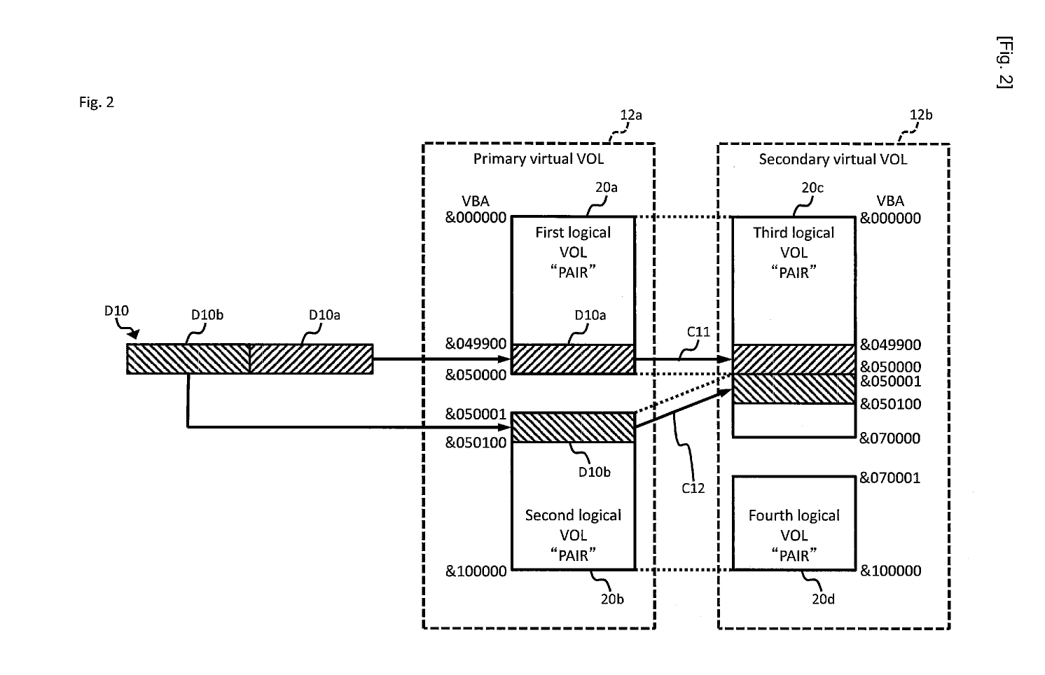

FIG. 2 is a schematic diagram for illustrating the relationship between the primary virtual VOL 12a and the secondary virtual VOL 12b and the respective logical VOLs 20.

The primary virtual VOL 12a comprises the first logical VOL 20a and the second logical VOL 20b. The secondary virtual VOL 12b comprises the third logical VOL 20c and the fourth logical VOL 20d. Virtual block addresses (hereinafter referred to as “VBA”) “000000 through 100000” are allocated to both the primary virtual VOL 12a and the secondary virtual VOL 12b. Upon receiving a “write” command together with a write-specified-destination VBA and data from the first host 14a, the data is written to a primary virtual VOL 12a storage area denoted by the write-specified-destination VBA.

The logical block addresses (hereinafter referred to as “LBA”) of each logical VOL 20 are associated with the VBA. In FIG. 2, the LBAs “000000 through 050000” of the first logical VOL 20a are associated with the VBAs “000000 through 050000” of the primary virtual VOL 12a, and the LBAs “000000 through 050000” of the second logical VOL 20b are associated with the VBAs “050001 through 100000” of the primary virtual VOL 12a. The LBAs “000000 through 070000” of the third logical VOL 20c are associated with the VBAs “000000 through 070000” of the secondary virtual VOL 12b, and the LBAs “000000 through 030000” of the fourth logical VOL 20d are associated with the VBAs “070001 through 100000” of the secondary virtual VOL 12b.

For example, in a case where a command for writing data D10 to VBAs “049900 through 050100” of the primary virtual VOL 12a has been received, the LBAs corresponding with these VBAs span the first logical VOL 20a and the second logical VOL 20b. In accordance with this, since the LBAs corresponding to the VBAs “049900 through 050000” of the primary virtual VOL 12a are in the first logical VOL 20a, data D10a is written to the LBAs “049900 through 050000” of the first logical VOL 20a (C9). Since the LBAs corresponding to the VBAs “050001 through 050100” of the primary virtual VOL 12a are in the second logical VOL 20b, data D10b is written to the LBAs “000000 through 000100” of the second logical VOL 20b (C10).

Meanwhile, since the LBAs corresponding to the VBAs “049900 through 050000” of the secondary virtual VOL 12b are in the third logical VOL 20c, data D10a is written to the LBAs “049900 through 050000” of the third logical VOL 20c (C11). Since the LBAs corresponding to the VBAs “050001 through 050100” of the secondary virtual VOL 12b are also in the third logical VOL 20c, data D10b is written to the LBAs “050001 through 050100” of the third logical VOL 20c (C12).

As described above, the data written to the primary virtual VOL 12a is also written to the secondary virtual VOL 12b. That is, the primary virtual VOL 12a and the secondary virtual VOL 12b store synchronized data.

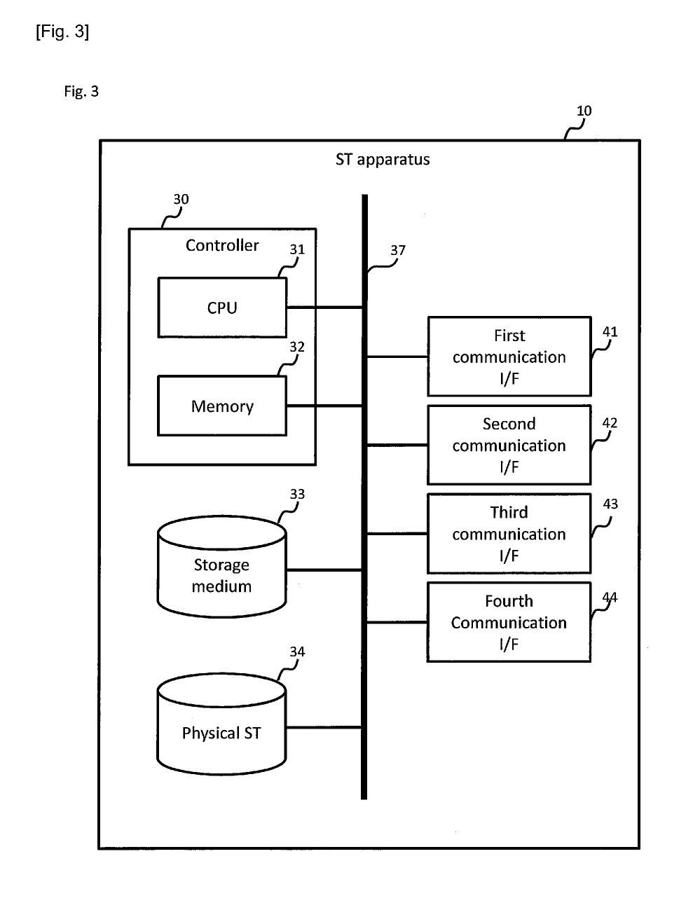

FIG. 3 is a diagram showing the hardware configuration of the ST apparatus 10. The ST apparatus 10 comprises a CPU 31, a memory 32, a storage medium 33, a physical ST 34, and communication interfaces (hereinafter referred to as “I/F”) 41 through 44, and the respective components 31 through 34 and 41 through 44 are coupled via a bus 37 to enable two-way data communications. The CPU 31 and the memory 32 may be collectively referred to as a controller 30.

The CPU 31 executes a process included in a computer program (hereinafter referred to as “program”) to realize a variety of functions, which will be explained further below.

The memory 32 is able to store data while power is being supplied. Since the memory 32 reads/writes data relatively rapidly, for example, it is used as a temporary storage area for data used by the CPU 31. The memory 32, for example, comprises a DRAM (Dynamic Random Access Memory).

The storage medium 33 is able to store data even while power is not being supplied. Therefore, for example, a program executed by the CPU 31 and setting information required when this program is executed are stored on the storage medium 33. The storage medium 33, for example, comprises either a HDD (Hard Disk Drive) or a flash memory.

The physical ST 34 is a physical ST for configuring a logical VOL 20. The logical VOL 20 mentioned above may be realized using a single physical ST 34, or may be realized by configuring multiple physical ST 34 into a RAID. The physical ST 34 may be provided inside the ST apparatus 10, or may be provided externally. The physical ST 34, for example, comprises either a HDD or a flash memory.

A cable, which enables the two-way sending and receiving of data, is coupled to the communication I/Fs 41 through 44, and this cable is coupled to either another ST apparatus 10 or a host 14. That is, the ST apparatus 10 can send/receive data to/from either another ST apparatus 10 or a host 14 by way of the communication I/Fs 41 through 44. For example, a first communication I/F 41 corresponds to a Port number (hereinafter referred to as “Port #”) 1, a second communication I/F 42 corresponds to a Port #2, a third communication I/F 43 corresponds to a Port #3, and a fourth communication I/F 44 corresponds to a Port #4. Hereinbelow, the Port # of the first ST apparatus may be referred to as “Port #Na (where N is 1, 2, 3, or 4), the Port # of the second ST apparatus may be referred to as “Port #Nb”, the Port # of the third ST apparatus may be referred to as “Port #Nc”, and the Port # of the fourth ST apparatus may be referred to as “Port #Nd”.

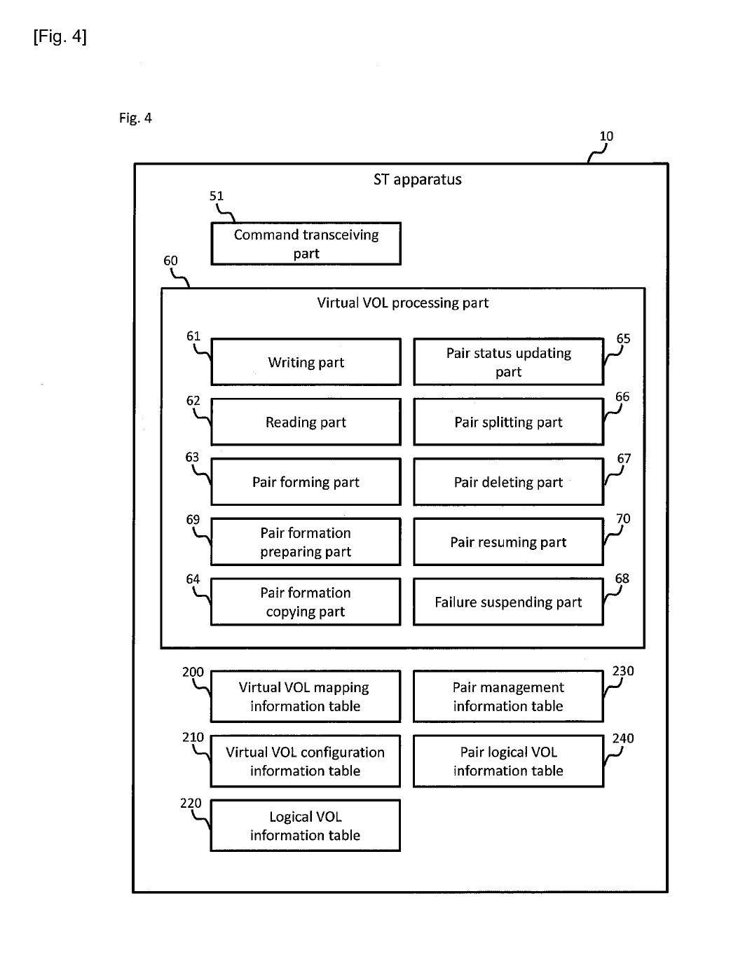

FIG. 4 is a diagram showing the functional configuration of the ST apparatus 10. The ST apparatus 10 comprises a command transceiving part 51, a virtual VOL processing part 60, a virtual VOL mapping information table 200, a virtual VOL configuration information table 210, a logical VOL information table 220, a pair management information table 230, and a pair logical VOL information table 240.

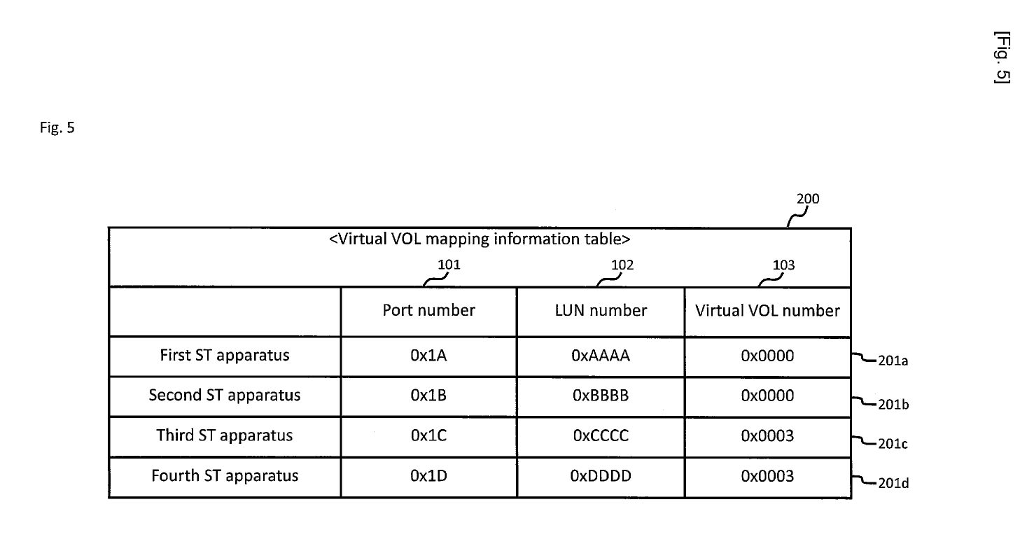

FIG. 5 is a diagram showing an example of the data configuration of the virtual VOL mapping information table 200. The virtual VOL mapping information table 200 comprises multiple virtual VOL mapping information 201. The virtual VOL mapping information 201 is created for each Port, which each ST apparatus 10 provides to a host 14. The virtual VOL mapping information 201 comprises a Port number 101, a LUN (Logical Unit Number) 102, and a virtual VOL number 103 as data items. The virtual VOL mapping information 201 is used for identifying the virtual VOL number 103 based on the Port number 101 and the LUN 102. Each ST apparatus 10 stores this virtual VOL mapping information table 200. The respective data items will be explained below.

The Port number 101 is a number, which enables the unique identification of a Port of a ST apparatus 10. The LUN 102, for example, is a number for identifying a case in which multiple devices exist inside a single unit in a SCSI-connected storage apparatus. The virtual VOL number 103 is a number for enabling the unique identification of a virtual VOL 12.

For example, virtual VOL mapping information 201a shows that the first ST apparatus 10a provides primary virtual VOL 12a having the virtual VOL number 103 “0x0000” with respect to Port number 101 “0x1A” and LUN 102“0xAAAA”.

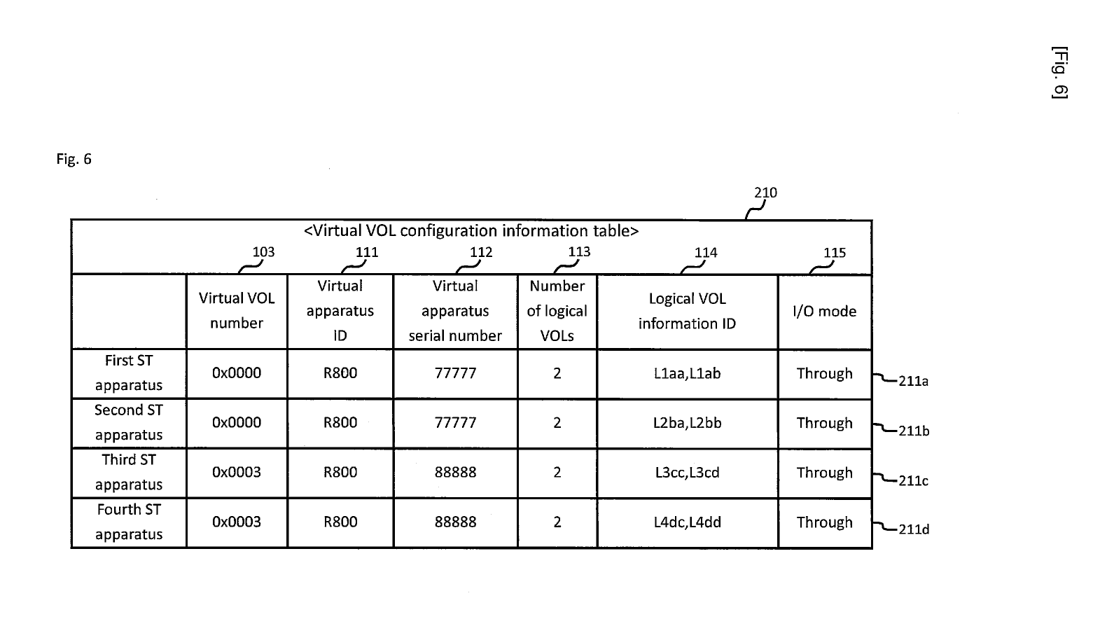

FIG. 6 is a diagram showing an example of the data configuration of the virtual VOL configuration information table 210. The virtual VOL configuration information table 210 comprises multiple virtual VOL configuration information 211. The virtual VOL configuration information 211 is created for each ST apparatus 10. The virtual VOL configuration information 211 comprises a virtual VOL number 103, a virtual apparatus ID (Identification) 111, a virtual apparatus serial number 112, a number of logical VOLs 113, a logical VOL information ID 114, and a I/O mode 115 as data items. Each ST apparatus 10 stores this virtual VOL configuration information table 210. The respective data items will be explained below.

The virtual VOL number 103 is the same as described hereinabove. The virtual apparatus ID 111 and the virtual apparatus serial number 112 are information virtually configured in the virtual VOL 12. In accordance with this, the host 14 is able to manage a virtual VOL 12 by treating it as an actual ST apparatus 10. The virtual VOL 12 is uniquely identified based on the combination of this virtual apparatus ID 111 and virtual apparatus serial number 112.

The number of logical VOLs 113 is information denoting how many logical VOLs 20 comprise the relevant virtual VOL 12. For example, since the primary virtual VOL 12a shown in FIG. 1 comprises two logical VOLs 20, i.e., the first logical VOL 20a and the second logical VOL 20b, the number of logical VOLs 113 is “2”.

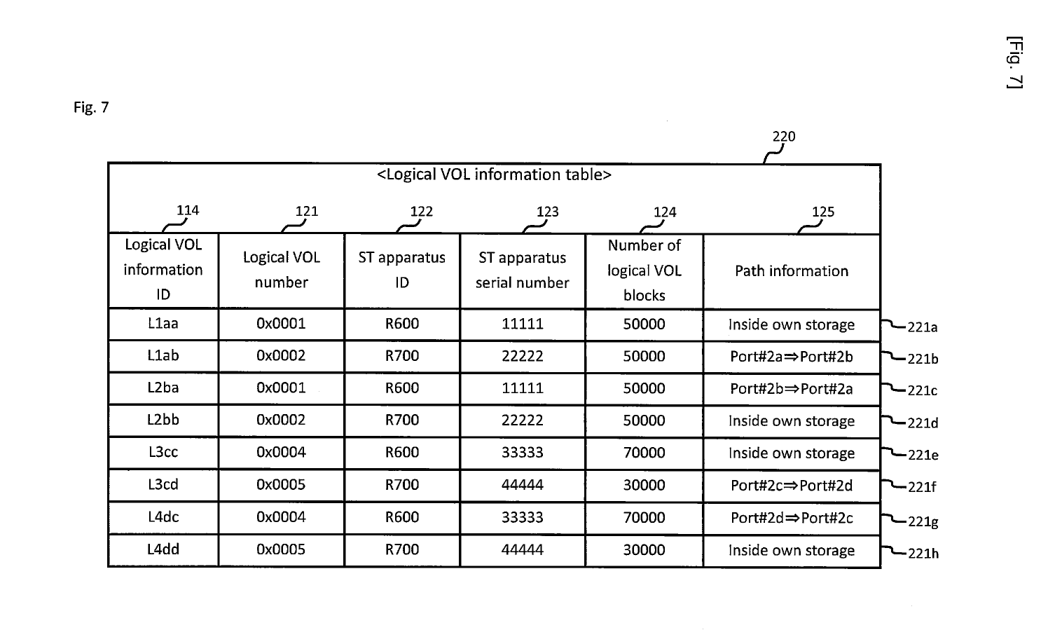

The logical VOL information ID 114 is information enabling the unique identification of respective logical VOL information 221 comprising the virtual VOL 12. The value of the logical VOL information ID 114 is linked to the value of the logical VOL information ID 114 of FIG. 7, which will be described further below. The number of logical VOL information IDs 114 is the same as the value of the number of logical VOLs 113.

The I/O mode 115 is information denoting the I/O mode of the relevant virtual VOL 12. For example, a value of “through”, “ReadHit” or “duplex” is configured in the I/O mode 115. When “through” has been configured, in a case where the write-specified-destination VBA on the “write” command is associated with the LBA of a logical VOL 20 other than the relevant logical VOL 20, the write data is transferred to this other logical VOL 20. When “ReadHit” has been configured, only the cache for a read is duplexed. When “duplex” has been configured, the cache for a write is duplexed.

For example, virtual VOL configuration information 211a shows that for the virtual VOL 12 having virtual VOL number 103 “0x0000”, the virtual apparatus ID 111 is “R800” and the virtual apparatus serial number 112 is “77777”. In addition, the virtual VOL configuration information 211a also shows that the number of logical VOLs 113 comprising this virtual VOL 12 is “2” and that the I/O mode 115 is “through”. The virtual VOL configuration information 211a also shows that the logical VOL information IDs 114 of the two logical VOLs 20 comprising this virtual VOL 12 are “L1aa” and “L1ab”, respectively. The value of the logical VOL information IDs 114 are linked to the values “L1aa” and “L1ab” of the logical VOL information IDs 114 of FIG. 7, which will be described further below.

FIG. 7 is a diagram showing an example of the data configuration of the logical VOL information table 220. The logical VOL information table 220 comprises multiple logical VOL information 221. The logical VOL information 221 comprises a logical VOL information ID 114, a logical VOL number 121, a ST apparatus ID 122, a ST apparatus serial number 123, a number of logical VOL blocks 124, and path information 125 as data items. The respective data items will be explained below.

The logical VOL information ID 114 is the same as described above. The value of this logical VOL information ID 114 is linked from the value of the logical VOL information ID 114 of FIG. 6 explained above. The logical VOL number 121 is a number for identifying a logical VOL 20.

The ST apparatus ID 122 and the ST apparatus serial number 123 show the ID and serial number of the ST apparatus 10, which realizes the logical VOL 20 denoted by the logical VOL number 121. The ST apparatus 10 can be uniquely identified by combining this ST apparatus ID 122 and ST apparatus serial number 123.

The number of logical VOL blocks 124 shows the number of logical blocks comprising the relevant logical VOL 20. Data is written and read in logical block units. In this example, it is supposed that one LBA is assigned to one logical block. The size of one logical block unit may be a SLOT (or a CYL (15 SLOTs)) rather than a LBA.

The path information 125 shows a path (a communication network channel) to another logical VOL 20 comprising the same virtual VOL 12. The path information 125 is denoted as “inside own storage” when denoting one's own logical VOL 20, and as “own ST apparatus Port number->other ST apparatus Port number” when denoting the other logical VOL 20. The path information 125 may store multiple pieces of path information for redundancy. In a case where multiple pieces of path information are stored in the path information 125, an appropriate path (for example, a normal path for which a failure has not occurred) is selected at communication time.

For example, the logical VOL information 221 of the logical VOL information ID 114 “L1aa” shows that the logical VOL number 121 is “0x0001”, the ST apparatus ID 122 is “R600”, the ST apparatus serial number 123 is “11111”, and the number of logical VOL blocks 124 is “50000”. In addition, the path information 125 corresponding to this logical VOL information ID 114 “L1aa” shows “inside own storage”.

For example, the logical VOL information 221 of the logical VOL information ID 114 “L1ab” shows that the logical VOL number 121 is “0x0002”, the ST apparatus ID 122 is “R700”, the ST apparatus serial number 123 is “22222”, and the number of logical VOL blocks 124 is “50000”. In addition, the path information 125 corresponding to this logical VOL information ID 114 shows “Port #2a->Port #2b”.

The logical VOL information IDs 114 “L1aa” and L1ab” are referenced from the virtual VOL configuration information 211a of FIG. 6. That is, referencing the virtual VOL configuration information 211a and the logical VOL information 221a and 221b makes it possible to learn the following. That is, it can be learned that the first ST apparatus 10a comprises a logical VOL 20 having the logical VOL number 121 “0x0001” provided “inside own storage”, and that a logical VOL 20 having the logical VOL number 121 “0x0002” is coupled via its own (first ST apparatus 10a) “Port #2a” and the second ST apparatus 10b “Port #2b”.

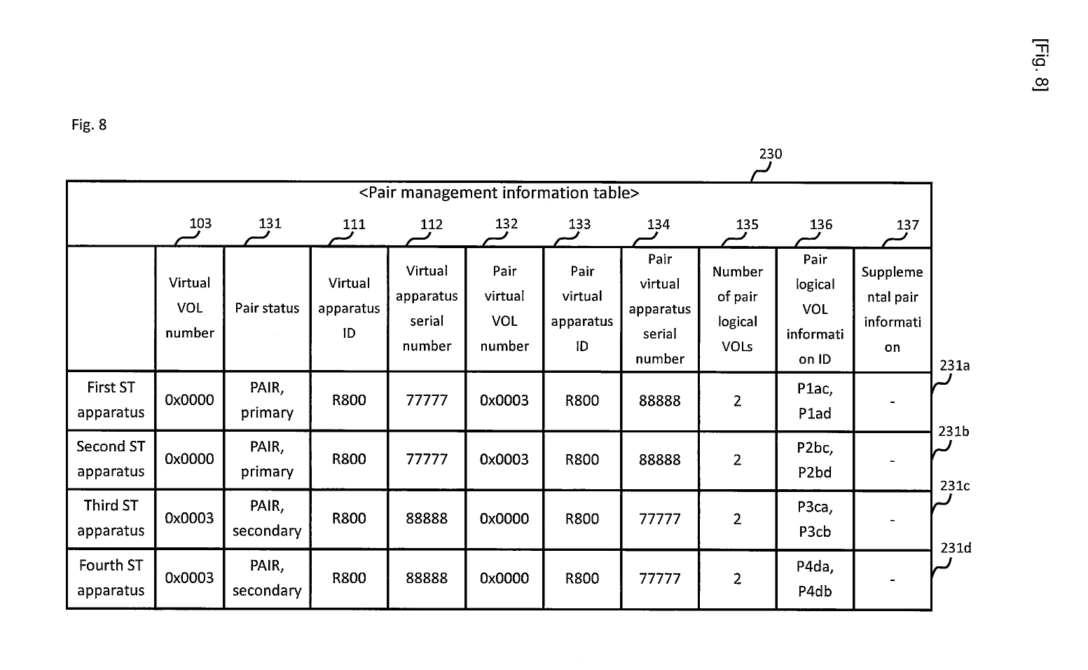

FIG. 8 is a diagram showing an example of the data configuration of the pair management information table 230. The pair management information table 230 comprises multiple pair management information 231. The pair management information 231 is created for each ST apparatus 10. The pair management information 231 comprises a virtual VOL number 103, a pair status 131, a virtual apparatus ID 111, a virtual apparatus serial number 112, a pair virtual VOL number 132, a pair virtual apparatus ID 133, a pair virtual apparatus serial number 134, a number of pair logical VOLs 135, pair logical VOL information 241, and supplemental pair information 137 as data items. The respective data items will be explained hereinbelow.

The virtual VOL number 103 is the same as was described hereinabove. The pair status 131 shows various states, such as whether or not each ST apparatus 10 is forming a pair, and a case where a pair is formed. The “primary” and “secondary” in the pair status 131 shows whether the ST apparatus 10 comprises the primary virtual VOL 12a or the secondary virtual VOL 12b. For example, “SMPL”, “COPY”, “PAIR”, “PSUS” and “PSUE” exist as the pair status 131. Each pair status 131 will be explained hereinbelow.

“SMPL” shows a state in which the ST apparatus 10 is not forming a pair. “SMPL” is the abbreviation for “Simplex”. This status is configured prior to a “pair formation process” and after a “pair deletion process”, which will be explained further below.

“COPY” shows a state in which the ST apparatus 10 is executing a copy. This status, for example, is configured during the prescribed period of the “pair formation process” and the prescribed period of a “pair resumption process”, which will be explained further below.

“PAIR” shows a state in which the ST apparatus 10 is forming a pair. This status, for example, is configured after the “pair formation process” and after the “pair resumption process”, which will be explained further below.

“PSUS” shows a state in which a “PAIR” has been temporarily cancelled. “PSUS” is the abbreviation for “Pair-Suspend”. That is, “PSUS” shows that data written to the primary virtual VOL 12a is not remote copied to the secondary virtual VOL 12b. This status, for example, is configured after a “pair splitting process”, which will be explained further below.

“PSUE” shows a state in which a “PAIR” is temporarily cancelled as a result of some sort of failure having occurred. “PSUE” is the abbreviation for “Pair-Suspend by Error”. That is, “PSUE” shows that data written to the primary virtual VOL 12a is not remote copied to the secondary virtual VOL 12b. This status, for example, is configured after a “failure suspension process”, which will be explained further below.

The virtual apparatus ID 111 and the virtual apparatus serial number 112 are as described above. The pair virtual VOL number 132 is the number of a virtual VOL 12, which forms a pair with the relevant virtual VOL 12. For example, the primary virtual VOL 12a forms a pair with the secondary virtual VOL 12b, and the secondary virtual VOL 12b forms a pair with the primary virtual VOL 12a. Hereinbelow, the virtual VOL 12, which forms a pair with the relevant virtual VOL 12, may be referred to as the pair virtual VOL 12.

The pair virtual apparatus ID 133 and the pair virtual apparatus serial number 134 are the virtual apparatus ID 111 and the virtual apparatus serial number 112 serial number assigned to the pair virtual VOL 12.

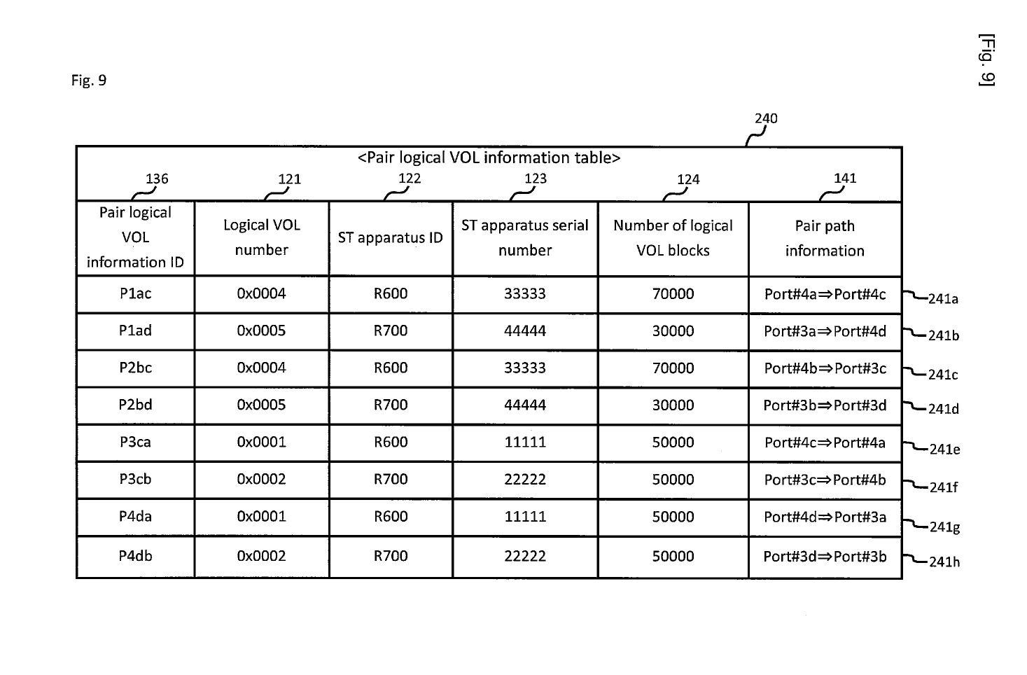

The number of pair logical VOLs 135 is the number of logical VOLs 20 comprising the pair virtual VOL 12. The pair logical VOL information ID 136 is information, which enables each piece of pair logical VOL information 241 comprising the pair virtual VOL 12 to be uniquely identified. The value of the pair logical VOL information ID 136 is linked to the value of the pair logical VOL information ID 136 of FIG. 9, which will be explained further below. The number of pair logical VOL information IDs 136 is the same as the value of the number of pair logical VOLs 135.

The supplemental pair information 137 shows supplemental information for the pair ST apparatus 10. For example, in a case where a “Freeze”, which will be explained further below, has been configured in the relevant ST apparatus 10, a value to this effect is set in the supplemental pair information 137.

For example, the pair management information 231a shows that for the virtual VOL 12 having the virtual VOL number 103 of “0x0000”, the virtual apparatus ID 111 is “R800” and the virtual apparatus serial number 112 is “77777”, and the pair status 131 is a “primary” “PAIR”. In addition, the pair management information 231a shows that for the pair virtual VOL 12 of the relevant virtual VOL 12, the pair virtual VOL number 132 is “0x0003”, the pair virtual apparatus ID 133 is “R800”, the pair virtual apparatus serial number 134 is “88888”, and the number of pair logical VOLs 135 comprising this pair virtual VOL 12 is “2”. The pair management information 231a also shows that the pair logical VOL information IDs 136 of the two pair logical VOLs 20 comprising this pair virtual VOL 12 are respectively “P1ac” and “P1ad”. The values of the pair logical VOL information IDs 136 are linked to the values “P1ac” and “P1ad” of the pair logical VOL information IDs 136 of FIG. 9, which will be explained further below.

FIG. 9 is a diagram showing an example of the data configuration of the pair logical VOL information table 240. The pair logical VOL information table 240 comprises multiple pair logical VOL information 241. The pair logical VOL information 241 comprises a pair logical VOL information ID 136, a logical VOL number 121, a ST apparatus ID 122, a ST apparatus serial number 123, a number of logical VOLs 124, and pair path information 141 as data items.

The pair logical VOL information ID 136 is the same as described hereinabove. The value of this pair logical VOL information ID 136 is linked from the value of the pair logical VOL information ID 136 of FIG. 8 described hereinabove.

The logical VOL number 121, the ST apparatus ID 122, the ST apparatus serial number 123, and the number of logical VOLs 124 are the same as described above.

The pair path information 141 shows the path (communication network channel) to the logical VOL 20 that forms a pair with the relevant logical VOL 20. The pair path information 141 is denoted as “Port # of own ST apparatus comprising relevant logical VOL->Port # of ST apparatus comprising pair logical VOL”. That is, data written to the logical VOL 20 comprising the primary virtual VOL 12a is remote copied to a prescribed logical VOL 20 comprising the secondary virtual VOL 12b via the channel shown in this pair path information 141. The pair path information 141 may store multiple pieces of pair path information for redundancy. In a case where multiple pieces of pair path information are stored in the pair path information 141, an appropriate pair path (for example, a normal pair path for which a failure has not occurred) is selected at communication time.

For example, the pair logical VOL information 241 of the pair logical VOL information ID 136 “P1ac” shows that the logical VOL number 121 is “0x0004”, the ST apparatus ID 122 is “R600”, the ST apparatus serial number 123 is “33333”, and the number of logical VOL blocks 124 is “70000”. The pair logical VOL information 241 also shows that the pair path information 141 corresponding to this pair logical VOL information ID 136 “P1ac” is “Port #4a->Port #4c”.

For example, the pair logical VOL information 241 of the pair logical VOL information ID 136 “P1ad” shows that the logical VOL number 121 is “0x0005”, the ST apparatus ID 122 is “R700”, the ST apparatus serial number 123 is “44444”, and the number of logical VOL blocks 124 is “30000”. The pair logical VOL information 241 also shows that the pair path information 141 corresponding to this pair logical VOL information ID 136 is “Port #3a->Port #4d”.

The pair logical VOL information IDs 136 “P1ac” and “P1ad” are referenced from the pair management information 231a of FIG. 8. That is, referencing the pair management information 231a and the pair logical VOL information 241a and 241b makes it possible to learn the following.

The first ST apparatus 10a is coupled to the pair logical VOL 20 having the logical VOL number 121 of “0x0004” (that is, the third logical VOL 20c) via a channel, which links its own (the first ST apparatus 10a) “Port #4a” to the third ST apparatus 10c “Port #4c” (refer to 241a).

The first ST apparatus 10a is coupled to the pair logical VOL 20 having the logical VOL number 121 of “0x0005” (that is, the fourth logical VOL 20d) via a channel, which links its own (the first ST apparatus 10a) “Port #3a” to the fourth ST apparatus 10d “Port #4d” (refer to 241b). The explanation will return to FIG. 3 below.

The command transceiving part 51 sends command data (hereinafter referred to as a “command”), which comprises the content to be executed by the ST apparatus 10, to another ST apparatus 10 or the like by controlling the communication I/Fs 41 through 44 (that is, the Ports). The command transceiving part 51 also receives a command from the other ST apparatus 10 or the like by way of the communication I/Fs 41 through 44 (that is, the Ports), and transfers this command to the virtual VOL processing part 60. The command will be explained in detail further below. There may be cases where the command is sent to the ST apparatus 10 from the host 14, and there may be cases where the ST apparatus 10 itself creates the command and sends this command to another ST apparatus 10.

The virtual VOL processing part 60 executes processing related to a virtual VOL 12 on the basis of either the contents of an instruction included in the command or its own judgment.

The virtual VOL processing part 60 comprises a writing part 61 for writing data to a virtual VOL 12, a reading part 62 for reading data from a virtual VOL 12, a pair forming part 63 for forming a virtual VOL 12 pair from a primary and a secondary virtual VOL 12, a pair formation preparing part 69 for making the preparations for forming a pair, a pair formation copying part 64 for copying data between the primary and secondary virtual VOLs 12, a pair status updating part 65 for updating the pair status 131 of the virtual VOLs 12, a pair splitting part 66 for splitting a formed pair, a pair deleting part 67 for deleting a formed pair, a failure suspending part 68 for splitting a formed pair when a failure occurs, and a pair resuming part 70 for resuming the split pair. Each of the parts 61 through 70 mentioned above will be explained below.

The writing part 61 writes prescribed data to the virtual VOL 12 in accordance with a “write” command sent from the host 14. The “write” command includes a Port number 101, a LUN 102, and a VBA showing the virtual VOL 12 write destination of the data. The writing part 61, which receives the “write” command from the port corresponding to this Port number 101, translates the VBA of this virtual VOL 12 to the LBA of the logical VOL 20. The virtual VOL 12 comprises multiple logical VOLs 20. Consequently, the writing part 61 identifies the logical VOL 20 to which this translated LBA corresponds, and writes the data to the identified logical VOL 20 LBA. The writing part 61 also writes the data written to the virtual VOL 12 to the pair virtual VOL 12, which forms a pair with the relevant virtual VOL 12. When performing this processing, the pair status 131 of each ST apparatus 10, which itself comprises a virtual VOL 12, and the pair status 131 of each ST apparatus 10, which comprises a pair virtual VOL 12, must both be either “PAIR” or “COPY”. This processing will be explained in detail further below.

The reading part 62 reads prescribed data from a virtual VOL 12 in accordance with a “read” command sent from the host 14. The “read” command comprises a Port number 101, a LUN 102, and a virtual VOL VBA showing the data read destination. The reading part 62, which receives the “read” command from the port corresponding to this Port number 101, translates the VBA of this virtual VOL 12 to a logical VOL 20 LBA. The reading part 62 identifies the logical VOL 20 to which this translated LBA corresponds, and reads the data from the identified logical VOL 20 LBA. When performing this processing, the pair status 131 of each ST apparatus 10, which itself comprises a virtual VOL 12, and the pair status 131 of each ST apparatus 10, which comprises a pair virtual VOL 12, may be any pair status. This is because a “read” command, unlike a “write” command, does not propagate to a pair virtual VOL.

The pair forming part 63 forms a virtual VOL 12 pair. That is, the pair forming part 63 forms a pair virtual VOL 12, which is synchronized to its own virtual VOL 12. The pair forming part 63, upon receiving a “form pair” command from the host 14, starts to form a pair between the relevant virtual VOL 12 and another virtual VOL 12 specified in the “form pair” command. The pair forming part 63 comprises three parts, i.e., the pair formation preparing part 69, the pair formation copying part 64, and the pair status updating part 65. The processing of these three parts will be explained below. Furthermore, this processing will be explained in detail further below.

The pair formation preparing part 69 acquires virtual VOL configuration information 211 and virtual VOL information 221 from its own ST apparatus 10 and a pair-candidate ST apparatus 10, and determines whether or not it is possible to form a pair with the pair-candidate ST apparatus 10. For example, the pair formation preparing part 69 compares the number of virtual VOL VBAs (the total number of logical VOL blocks), and in a case where the number of VBAs of its own ST apparatus matches the number of VBAs of the pair-candidate ST apparatus, determines that pair formation is possible, and in a case where there is no match, determines that pair formation is not possible. Then, in a case where a determination has been made that pair formation is possible, the pair formation copy preparing part sends a command to the pair-candidate ST apparatus 10 to the effect “update pair status 131 to ‘COPY’”, and updates its own pair status 131 to “COPY”. At the stage at which the pair status 131 of the ST apparatus 10, which comprises its own virtual VOL 12, and all the ST apparatuses 10, which comprise pair-candidate virtual VOLs 12, has been updated to “COPY”, the pair formation preparing part 69 ends this processing as the preparations for pair formation copying have been completed. At this point, its own virtual VOL 12 is regarded as the “primary virtual VOL 12a” and the pair-partner virtual VOL 12 is regarded as the “secondary virtual VOL 12b”.

The pair formation copying part 64 copies all the data of the primary virtual VOL 12a to the secondary virtual VOL 12b. That is, the pair formation copying part 64 sends a “pair formation copy” command to another ST apparatus 10 comprising the same primary virtual VOL 12a, and, in addition, remote copies all the data stored in its own ST apparatus 10 (logical VOL 20) to the other ST apparatus 10 comprising the secondary virtual VOL 12b. Then, at the stage at which RCP has been completed for all the ST apparatuses 10 comprising the primary virtual VOL 12a and the secondary virtual VOL 12b, the pair formation copying part 64 ends this processing as all copying has been completed.

The pair status updating part 65 updates the pair status 131 of all the ST apparatuses 10 comprising the primary virtual VOL 12a and the secondary virtual VOL 12b from “COPY” to “PAIR”. In accordance with this, a virtual VOL 12 pair is formed, and the above-described write processing is realized.

The pair splitting part 66 temporarily splits (cancels) the pair relationship of the primary virtual VOL 12a and the secondary virtual VOL 12b. The pair splitting part 66, upon receiving a “split pair” command from the host 14, sends a command to the effect “update pair status 131 to ‘PSUS’” to another ST apparatus 10 comprising the same virtual VOL 12, and, in addition, also sends a command to the effect “update pair status 131 to ‘PSUS’” to the ST apparatus 10 comprising the pair virtual VOL 12. Each ST apparatus 10, which receives this command, updates its own pair status 131 from “PAIR” to “PSUS”. Then, at the stage at which the pair status 131 of all the ST apparatuses 10 comprising the virtual VOL 12 and the pair virtual VOL 12 has transitioned to “PSUS”, the pair splitting part 66 ends this processing. That is, the data written to the primary virtual VOL 12a is not remote copied to the secondary virtual VOL 12b. This pair splitting process, for example, is executed in a case where the ST apparatus 10 comprising the secondary virtual VOL 12b is to undergo maintenance.

However, the fact that each ST apparatus 10 updates its respective pair status 131 from “PAIR” to “PSUS” at the stage at which a command to the effect “update pair status 131 to ‘PSUS’” has been received causes a situation in which a ST apparatus 10 having a pair status 131 of “PAIR” and a ST apparatus 10 having a pair status 131 of “PSUS” temporarily coexist. Under these circumstances, there occurs a situation in which a portion of the data is remote copied to the secondary virtual VOL 12b and a portion of the data is not remote copied to the secondary virtual VOL 12b. Accordingly, to prevent this situation from occurring, the pair splitting part 66 configures “Freeze” in all the logical VOLs 20 comprising the primary virtual VOL 12a prior to updating the pair status 131 to “PSUS”. Thereafter, data is not written to a logical VOL 20 for which “Freeze” has been configured. The concept behind this “Freeze” will be explained below using a drawing.

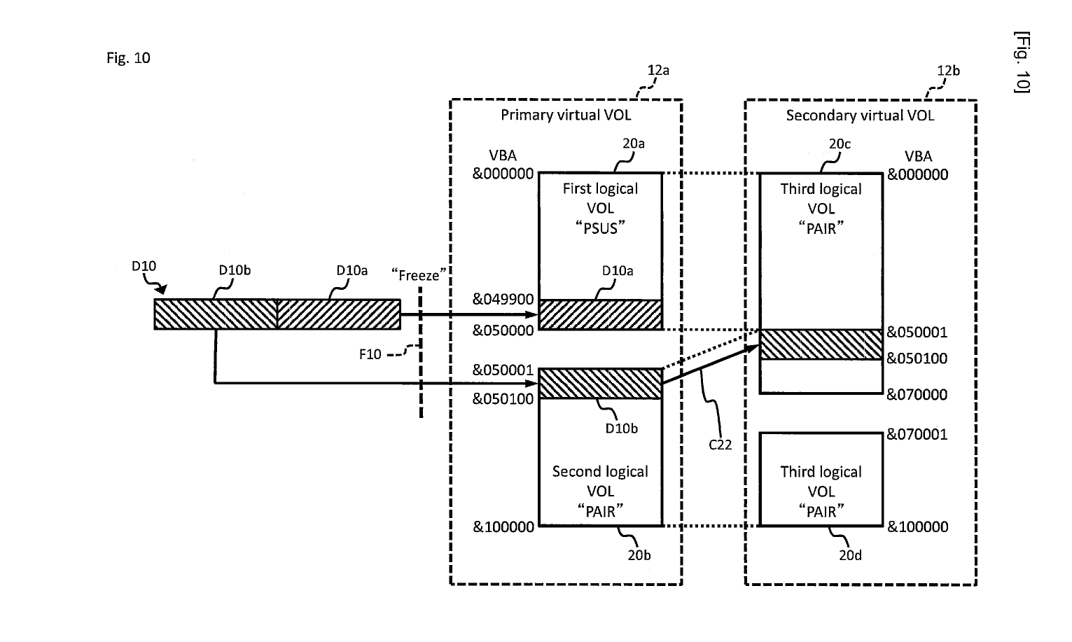

FIG. 10 is a schematic diagram showing the concept of a “Freeze”. First of all, the mechanism by which there occurs a situation in which a portion of the data is remote copied to the secondary virtual VOL 12b and a portion of the data is not remote copied to the secondary virtual VOL 12b in the above-described case in which the pair statuses 131 are a mixture of “PSUS” and “PAIR” will be explained.

For example, it is supposed that a “write” command for writing data D10 has been received from the host 14. Then, it is supposed that data D10a, which is the first half of this data D10, is written to the first logical VOL 20a, and that data D10b, which is the second half, is written to the second logical VOL 20b. It is further supposed that the pair status 131 of the first logical VOL 20a at this time is “PSUS” and that the pair status 131 of the second logical VOL 20b is “PAIR”. In accordance with this, since the pair status 131 of the first logical VOL 20a is “PSUS”, the data D10a, which has been written to the first logical VOL 20a, is not remote copied to the third logical VOL 20c. However, since the pair status 131 of the second logical VOL 20b is “PAIR”, the data D10b, which has been written to the second logical VOL 20b, is remote copied to the third logical VOL 20c (C22). That is, only the data D10b, which is the second half of the data D10, is stored in the secondary virtual VOL 12b, giving rise to a situation in which the sequence of the data is not guaranteed.

Consequently, the pair splitting part 66 configures all the logical VOLs 20 comprising the primary virtual VOL 12a (that is, the first logical VOL 20a and the second logical VOL 20b) to “Freeze” prior to updating the pair status 131 from “PAIR” to “PSUS”. A logical VOL 20, which has been configured to “Freeze”, suspends data writes. For example, when “Freeze” is configured for the first logical VOL 20a in FIG. 10 (F10), the first logical VOL 20a suspends the writing of the data D10 until the “Freeze” has been cancelled. Since neither data D10a nor data D10b is written to the primary virtual VOL 12a in accordance with this, it is possible to prevent a situation in which only the data D10b, which is the second half of the data D10, is stored in the secondary virtual VOL 12b as described hereinabove. The “Freeze” of each logical VOL 20 is cancelled at the stage at which the pair status 131 of each logical VOL 20 has been updated to “PSUS”. The explanation will return to FIG. 4.

The pair resuming part 70 resumes the pair between the primary virtual VOL 12a and the secondary virtual VOL 12b for which the pair had been temporarily cancelled by the pair splitting part 66. Upon receiving a “resume pair” command from the host 14, the pair forming part 63 sends a command to the effect “update pair status 131 to ‘COPY’” to each ST apparatus 10 for which pair is to be resumed. Then, after the pair status 131 of all the ST apparatuses 10 has been updated to “COPY”, the pair resuming part 70 remote copies the data, which was written to the primary virtual VOL 12a, and, in addition, which was not written to the secondary virtual VOL 12b when the pair status 131 was “PSUS” (hereinafter referred to as “difference data”), from each ST apparatus 10 comprising the primary virtual VOL 12a to each ST apparatus 10 comprising the secondary virtual VOL 12b. Then, after the RCP of all the difference data has been completed, the pair resume processing part updates the pair status 131 of all the ST apparatuses 10 to “PAIR” and ends this processing.

The pair deleting part 67 deletes the pair relationship of the primary virtual VOL 12a and the secondary virtual VOL 12b. The pair deleting part 67, upon receiving a “delete pair” command from the host 14, configures “Freeze” with respect to all the logical VOLs 20 comprising the primary virtual VOL 12a. Then, after “Freeze” has been configured for all the logical VOLs 20, the pair deleting part 67 sends a command to the effect “update pair status 131 to ‘SMPL’” to all the logical VOLs 20. After the pair status 131 of each logical VOL 20 has been updated to “SMPL”, the pair deleting part 67 then cancels the “Freeze” setting.

The failure suspending part 68 temporarily separates a pair relationship in a case where some sort of failure has occurred in the ST apparatus 10. The content of the processing is substantially the same as the pair spitting process, but differs in that the pair status 131 is “PSUE”. The failure suspending part 68, upon detecting a failure, configures “Freeze” for all the logical VOLs 20 comprising the primary virtual VOL 12a. Then, after “Freeze” has been configured for all the logical VOLs 20, the failure suspending part 68 sends a command to the effect “update pair status 131 to ‘PSUE’” to all the logical VOLs 20. Then, after the pair status 131 has been updated to “PSUE” for each logical VOL 20, the failure suspending part 68 cancels the “Freeze” setting. In a case where failure recovery has been performed, a pair can be resumed in accordance with the pair resume process.

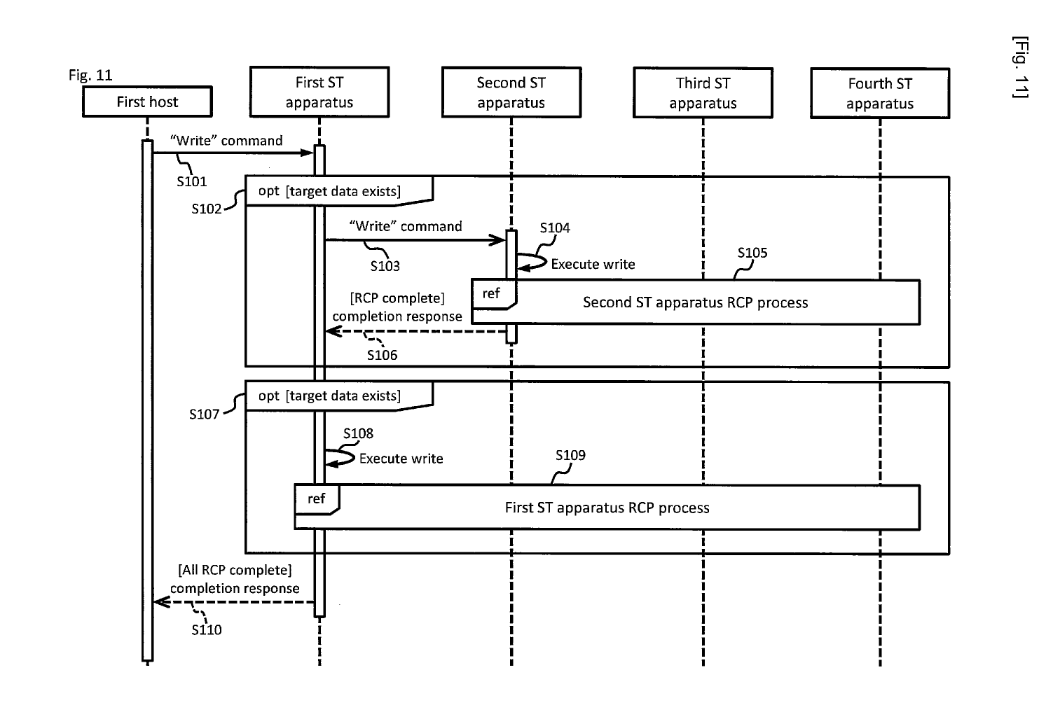

FIG. 11 is a sequence chart showing an example of processing relative to the “write” command. This processing is executed primarily by the writing part 61.

The first ST apparatus 10a, upon receiving a “write” command together with a write-destination VBA and data from the first host 14a (S101), makes a determination as to whether or not either all or a portion of the VBA to which this data is to be written is associated with LBA of the second logical VOL 20b of the second ST apparatus 10b (S102).

In a case where the VBA is associated with the LBA of the second logical VOL 20b here (S102: opt: target data exists), the processing of the following Steps S103 through S106 is executed, and in a case where there is no association, the first ST apparatus 10a moves to the processing of Step S107.

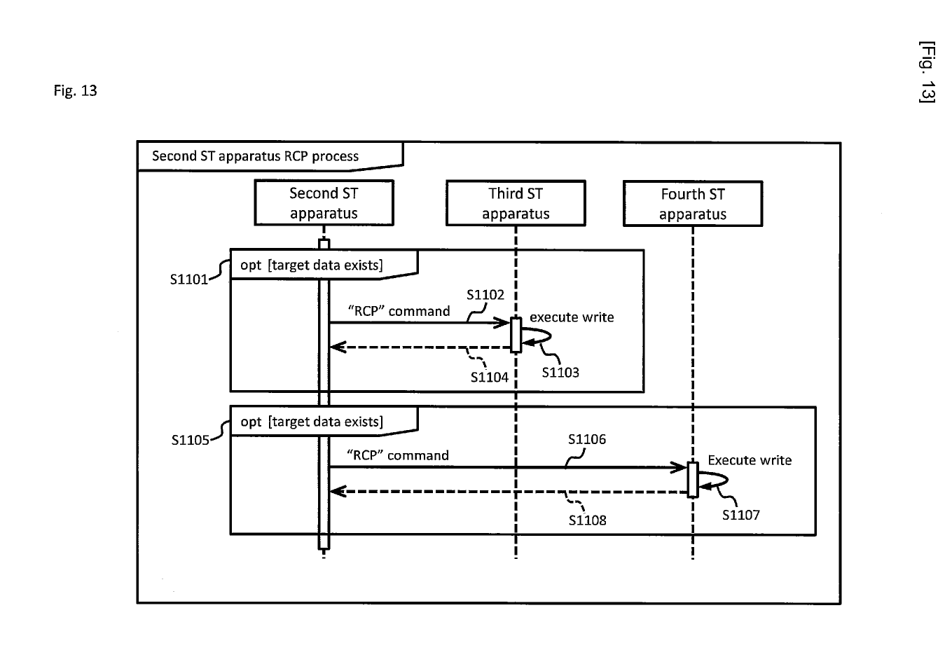

The processing of Steps S103 through S106 is as follows. The first ST apparatus 10a sends the “write” command to the second ST apparatus 10b (S103), and moves the processing to the next Step S107 without waiting for a completion response relative to this “write” command (S106). Meanwhile, the second ST apparatus 10b, which receives the “write” command from the first ST apparatus 10a (S103), writes the received data to the prescribed LBA of its own second logical VOL 20b (S104). Then, the second ST apparatus 10b executes the second ST apparatus 10b RCP process (S105), and returns a completion response to the first ST apparatus 10a when this processing is complete (S106). The RCP processing (S105) of the second ST apparatus 10b will be explained in detail further below by referring to FIG. 13, and in FIG. 13 the completion of Step S105 refers to the receipt of both a completion response (S1104) in a case where Step S1102 has been executed and a completion response (S1108) in a case where Step S1106 has been executed.

Next, the processing of Step S107 and beyond will be explained. The first ST apparatus 10a makes a determination as to whether or not either all or a portion of the VBA received in Step S101 is associated with the LBA of the first logical VOL 20a of itself (the first ST apparatus 10a) (S107).

In a case where the VBA is associated with the LBA of the first logical VOL 20a here (S107: opt: target data exists), the processing of the following Steps S108 and S109 is executed, and in a case where there is no association, the first ST apparatus 10a moves to the processing of Step S110.

The processing of Steps S108 and S109 is as follows. The first ST apparatus 10a writes the target data to the LBA of its own first logical VOL 20a (S108). Then, the first ST apparatus 10a executes the first ST apparatus 10a RCP process (S109). The RCP processing (S109) of the first ST apparatus 10a will be explained in detail further below.

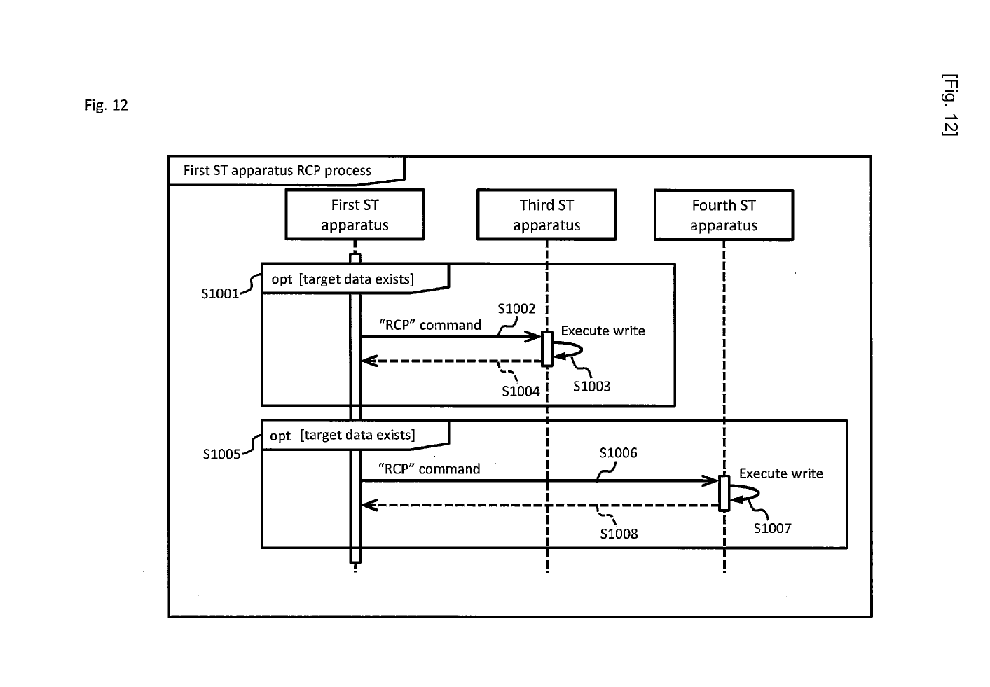

Next, the processing of Step S110 will be explained. The first ST apparatus 10a returns a completion response to the first host 14a (5110) after all of the write processing and RCP processing in the first ST apparatus 10a and the second ST apparatus 10b have been completed. That is, the first ST apparatus 10a, after checking the completion response in a case where Step S103 was executed (S106) and the completion of Step S109 in a case where Step S108 was executed, returns a completion response (S110) to the first host 14a. The completion of Step S109 here refers to the receipt of both a completion response (S1004) in a case where Step S1002 has been executed and a completion response (S1007) in a case where Step S1006 has been executed in FIG. 12, which will be described below.

FIG. 12 is a sequence chart showing an example of the RCP processing of the first ST apparatus 10a. This process is executed as part of the processing of the writing part 61 described hereinabove.

The first ST apparatus 10a determines whether or not either all or a portion of the VBA of the data written in Step S108 of FIG. 11 is associated with a LBA of the third logical VOL 20c of the third ST apparatus 10c (S1001).

In a case where the VBA is associated with the LBA of the third logical VOL 20c here (S1001: opt: target data exists), the first ST apparatus 10a executes the processing of the following Steps S1002 through S1004, and in a case where there is no association, regards the processing of the Steps S1002 through S1005 as having been completed without being executed and moves to the processing of Step S1005.

The processing of Steps S1002 through S1004 is as follows. The first ST apparatus 10a sends a “RCP” command to the third ST apparatus 10c (S1002) and moves the processing to the next Step S1005 without waiting for the completion response (S1004). The third ST apparatus 10c, upon receiving the “RCP” command (S1002), writes this “RCP” command together with the received data to the LBA of its own third logical VOL 20c (S1003), and returns a completion response (S1004).

Next, the processing of Step S1005 and beyond will be explained. The first ST apparatus 10a determines whether or not either all or a portion of the VBA of the data written in Step S108 of FIG. 11 is associated with the LBA of the fourth logical VOL 20d of the fourth ST apparatus 10d (S1005).

In a case where the VBA is associated with the LBA of the fourth logical VOL 20d here (S1005: opt: target data exists), the first ST apparatus 10a executes the processing of the following Steps S1006 through S1008, and in a case where there is no association, regards the processing of the Steps S1006 through S1008 as having been completed without actually being executed.

Next, the processing of Steps S1006 through S1008 will be explained. The first ST apparatus 10a sends the “RCP” command to the fourth ST apparatus 10d (S1006). The fourth ST apparatus 10d, upon receiving the “RCP” command (S1006), writes this “RCP” command together with the received data to the LBA of its own fourth logical VOL 20d (S1007) and returns a completion response (S1008).

FIG. 13 is a sequence chart showing an example of the RCP processing of the second ST apparatus 10b. This process is executed mainly as part of the processing of the writing part 61 described hereinabove.

The second ST apparatus 10b determines whether or not either all or a portion of the VBA of the data written in Step S104 of FIG. 11 is associated with a LBA of the third logical VOL 20c of the third ST apparatus 10c (S1101).

In a case where the VBA is associated with the third logical VOL 20c here (S1101: opt: target data exists), the second ST apparatus 10b executes the processing of the following Steps S1102 through S1104, and in a case where there is no association, regards the processing of the Steps S1102 through S1105 as having been completed without actually being executed and moves to the processing of Step S1105.

Next, the processing of Steps S1102 through S1104 will be explained. The second ST apparatus 10b sends a “RCP” command to the third ST apparatus 10c (S1102), and moves the processing to the next Step S1105 without waiting for the completion response (S1104). The third ST apparatus 10c, upon receiving the “RCP” command (S1102), writes this “RCP” command together with the received data to the LBA of its own third logical VOL 20c (S1103) and returns a completion response (S1104).

Next, the processing of Step S1105 and beyond will be explained. The second ST apparatus 10b determines whether or not either all or a portion of the fourth ST apparatus 10d VBA of the data written in Step S108 of FIG. 11 is associated with the LBA of the fourth logical VOL 20d of the fourth ST apparatus 10d (S1105).

In a case where the VBA is associated with the fourth logical VOL 20d here (S1105: opt: target data exists), the second ST apparatus 10b executes the processing of the following Steps S1106 through S1108, and in a case where there is no association, regards the processing of the Steps S1106 through S1108 as having been completed without actually being executed.

Next, the processing of Steps S1106 through S1108 will be explained. The second ST apparatus 10b sends the “RCP” command to the fourth ST apparatus 10d (S1106). The fourth ST apparatus 10d, upon receiving the “RCP” command (S1106), writes this “RCP” command together with the received data to the LBA of its own fourth logical VOL 20d (S1107), and returns a completion response (S1108).

The second ST apparatus 10b, upon completing the processing of both the Steps S1102 through S1104 and the Steps S1106 through S1108, moves the processing to Step S106. The first ST apparatus 10a, upon completing the processing of both the Steps S1002 through S1004 and the Steps S1006 through S1008, and, in addition, receiving a completion response from the second ST apparatus 10b (S106), returns a completion response to the first host (S110).

According to the above processing, the data written to the primary virtual VOL 12a is remote copied to the secondary virtual VOL 12b. That is, the data written to the first logical VOL 20a and/or the second logical VOL 20b, which comprise the primary virtual VOL 12a, is remote copied to the third logical VOL 20c and/or the fourth logical VOL 20d, which comprise the secondary virtual VOL 12b.

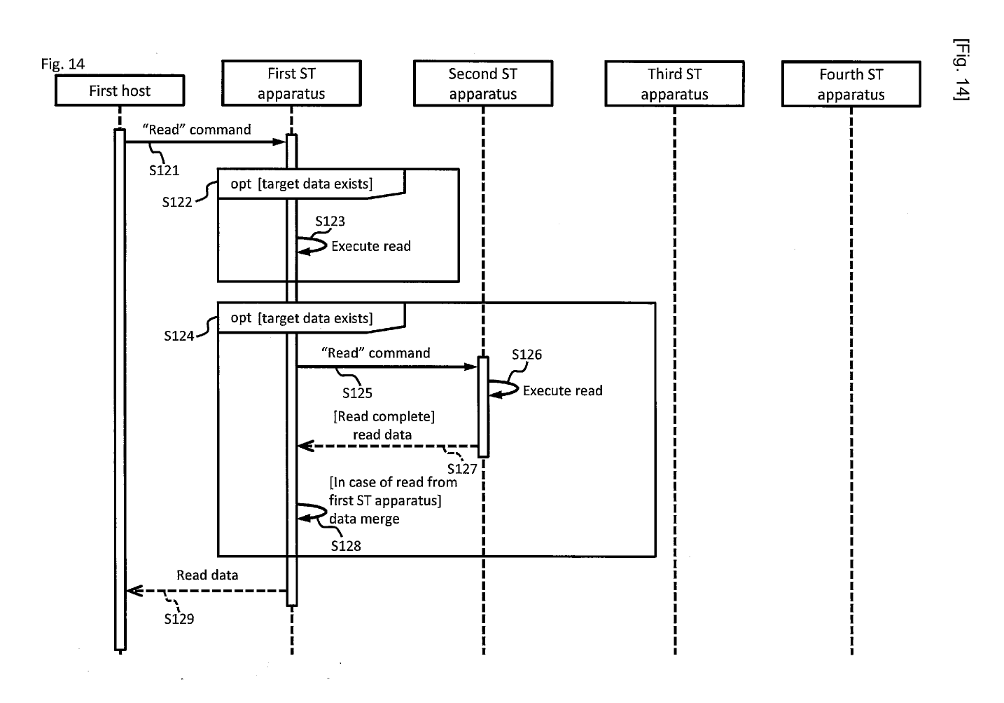

FIG. 14 is a sequence chart showing an example of processing relative to a “read” command. This processing is executed mainly by the reading part 62.

The first ST apparatus 10a, upon receiving a “read” command from the first host 14a (S121), makes a determination as to whether or not either all or a portion of the VBA of the read destination is associated with the LBA of its own (the first ST apparatus 10a) first logical VOL 20a (S122).

In a case where the VBA is associated with the first logical VOL 20a LBA here (S102: opt: target data exists), the first ST apparatus 10a executes processing for reading data from this LBA (S123), and moves to the processing of Step S124. In a case where there is no association, the first ST apparatus 10a moves to the processing of Step S124 as-is.

Next, the processing of Step S124 and beyond will be explained. The first ST apparatus 10a makes a determination as to whether or not either all or a portion of the VBA received in Step S121 is associated with the LBA of the second logical VOL 20b of the second ST apparatus 10b (S124).

In a case where the VBA is associated with the second logical VOL 20b LBA here (S124: opt: target data exists), the first ST apparatus 10a executes the processing of the following Steps S125 through S128, and thereafter, moves to the processing of Step S129. In a case where there is no association, the first ST apparatus 10a moves to the processing of Step S129 as-is.

The processing of Steps S125 through S128 is as follows. The first ST apparatus 10a sends a “read” command to the second ST apparatus 10b (S125) and waits for the response. The second ST apparatus 10b, upon receiving this “read” command, reads data from the LBA of the second logical VOL 20b specified in this “read” command, and returns this read data to the first ST apparatus 10a (S127). The first ST apparatus 10a receives the data from the second ST apparatus 10b (S127). In a case where the first ST apparatus 10a has also read data from its own first logical VOL 20a, the first ST apparatus 10a merges the data received from the second logical VOL 20b with this data (S128).

The processing of Step S129 will be explained next. The first ST apparatus 10a returns the read data to the first host 14a together with the completion response (S129).

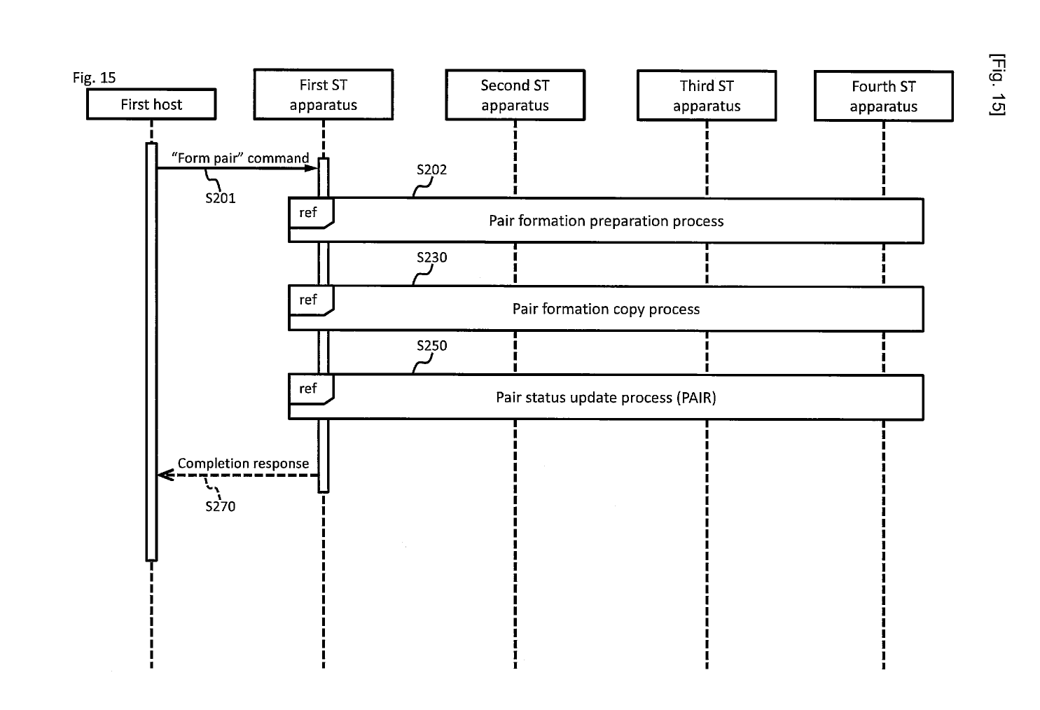

FIG. 15 is a sequence chart showing an example of processing relative to a “form pair” command. This processing is executed mainly by the pair forming part 63.

The first ST apparatus 10a, upon receiving a “form pair” command from the first host 14a (S201), first executes a pair formation preparation process (S202), next executes a pair formation copy process (S230), and after that executes a pair status 131 “PAIR” update process (S250). Then, after having completed the processing of Step S250, the first ST apparatus 10a returns a completion response to the first host 14a (S270). The processing of Steps S202, S230, and S250 will be explained in detail hereinbelow.

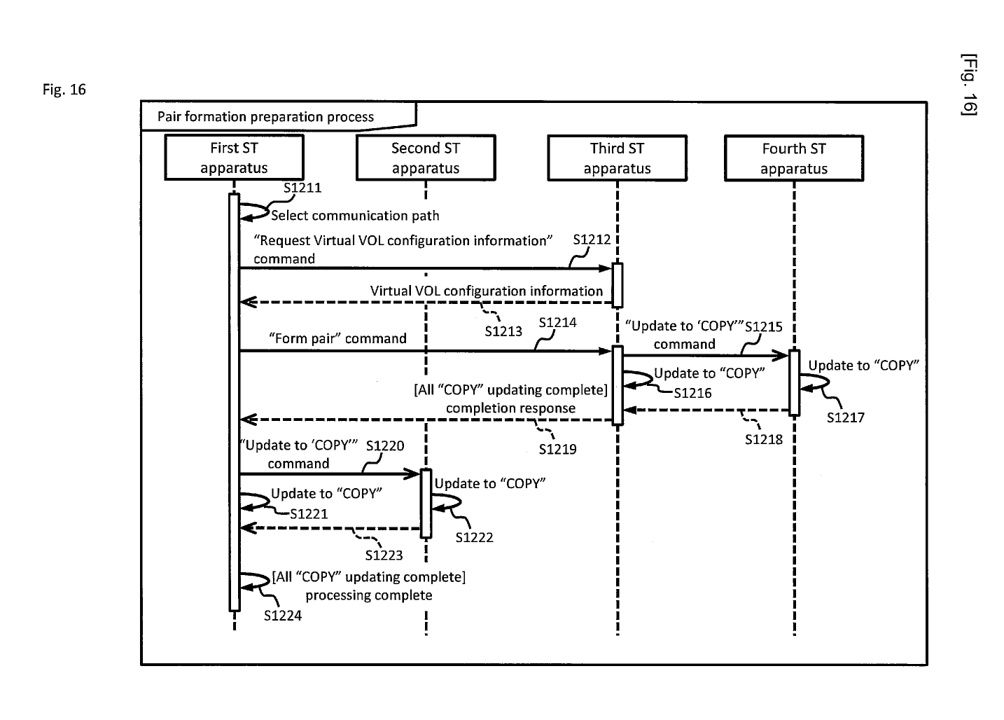

FIG. 16 is a sequence chart showing an example of a pair formation preparation process. This processing is executed mainly by the pair formation preparing part 69.

The first ST apparatus 10a references the pair path information 141 of the pair logical VOL information 241 and selects a communication path (S1211). The method for selecting this communication path will be explained in Example 3 below. It is supposed here that the third ST apparatus 10c has been selected as the communication path destination.

The first ST apparatus 10a then sends a “request virtual VOL configuration information 211 and logical VOL information 221” command to the third ST apparatus 10c (S1212) and acquires virtual VOL configuration information 211 from the third ST apparatus 10c (S1213).

Next, the first ST apparatus 10a compares the virtual VOL configuration information 211 and the logical VOL information 221, which it itself holds, to the virtual VOL configuration information 211 and the logical VOL information 221 acquired from the third ST apparatus 10c. Then, in a case where it is possible to form a pair with the third ST apparatus 10c, the first ST apparatus 10a sends a “form pair” command to the third ST apparatus 10c (S1214) and waits for the completion response (S1219). In a case where it is not possible to form a pair with the third ST apparatus 10c, the first ST apparatus 10a may notify the first host 14a to this effect and end this pair formation processing.

The third ST apparatus 10c, which has received the “form pair” command (S1214), sends a command to the effect “update the pair status 131 to ‘COPY’” to the fourth ST apparatus 10d (S1215), and, in addition, updates its own (third ST apparatus 10c) pair status 131 to “COPY” (S1216). The fourth ST apparatus 10d, which has received the command to the effect “update pair status 131 to ‘COPY’” (S1215), updates its own pair status 131 to “COPY” (S1217), and returns a completion response to the third ST apparatus 10c (S1218). When the third ST apparatus 10c has received the completion response from the fourth ST apparatus (S1218) and has completed updating its own (third ST apparatus 10c) pair status 131, the third ST apparatus 10c returns a completion response to the first ST apparatus 10a (S1219).

The first ST apparatus 10a, upon receiving the completion response from the third ST apparatus 10c (S1219), sends a command to the effect “update pair status 131 to ‘COPY’” to the second ST apparatus 10b (S1220), and, in addition, updates its own (first ST apparatus 10a) pair status 131 to “COPY” (S1221).

The second ST apparatus 10b, which receives the command to the effect “update pair status 131 to ‘COPY’” (S1220), updates its own (second ST apparatus 10b) pair status 131 to “COPY” (S1221), and returns a completion response to the first ST apparatus 10a (S1223).

The first ST apparatus 10a ends this copy formation processing when the pair status 131 of all ST apparatuses 10 is “COPY” (S1224). That is, when the first ST apparatus 10a has received the completion response from the second ST apparatus 10b (S1222) and has completed updating its own (first ST apparatus 10a) pair status 131 (S1223), the first ST apparatus 10a ends this copy formation processing (S1224).

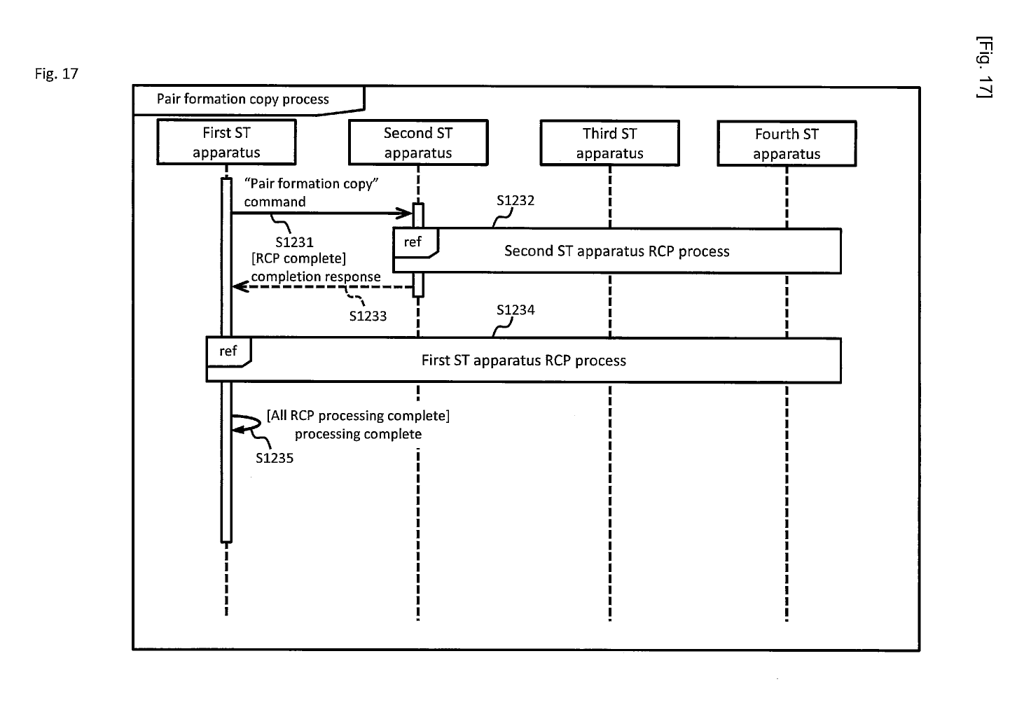

FIG. 17 is a sequence chart showing an example of a pair formation copy process. This processing is executed mainly by the pair formation copying part 64.

The first ST apparatus 10a sends a “pair formation copy” command to the second ST apparatus 10b (S1231), and moves to the processing of the next Step S1234 without waiting for a completion response with respect to this command (S1233).

The second ST apparatus 10b, upon receiving the “pair formation copy” command from the first ST apparatus 10a (S1231), segments into appropriate sizes (for example, 2000 pieces of data each) all of the data of the LBAs (for example, 50000), which comprise the second logical VOL 20b of the second ST apparatus 10b, and executes RCP processing (S1232). Then the second ST apparatus 10b returns a completion response to the first ST apparatus 10a (S1233) after completing this processing. The RCP processing of this Step S1232 is the same as the processing shown in FIG. 13 above.

Next, the first ST apparatus 10a segments into appropriate sizes (for example, 2000 pieces of data each) all of the data of the LBAs (for example, 50000), which comprise the first logical VOL 20a of the first ST apparatus 10a, and executes RCP processing (S1234). The RCP processing of this Step S1234 is the same as the processing shown in FIG. 12 above.

Then, when the RCP processing for all the apparatuses has been completed, the first ST apparatus 10a ends this pair formation copy processing (S1235). That is, when the first ST apparatus 10a has received the completion response from the second ST apparatus 10b (S1233) and has completed the first ST apparatus 10a RCP processing (S1234), the first ST apparatus 10a ends this pair formation copy processing (S1235).

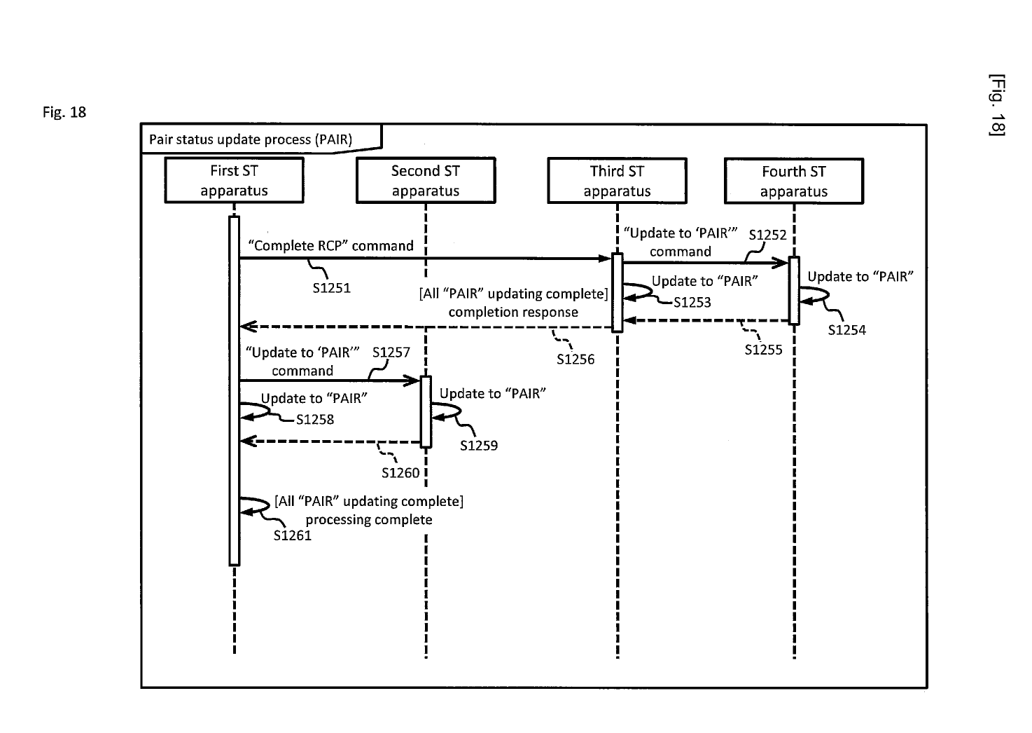

FIG. 18 is a sequence chart showing an example of pair status 131 change processing.

The first ST apparatus 10a sends a “complete RCP” command to the third ST apparatus 10c (S1251).

The third ST apparatus 10c, which receives the “complete RCP” command (S1251), sends a command to the effect “update pair status 131 to ‘PAIR’” (S1252) to the fourth ST apparatus 10d, and, in addition, updates its own (third ST apparatus 10c) pair status 131 to “PAIR” (S1253).

The fourth ST apparatus 10d, which receives the command to the effect “update pair status 131 to ‘PAIR’” (S1252), updates its own pair status 131 to “PAIR” (S1254), and returns a completion response to the third ST apparatus 10c (S1255).

When the third ST apparatus 10c has received the completion response from the fourth ST apparatus 10d (S1255) and has completed updating its own (third ST apparatus 10c) pair status 131 (S1253), the third ST apparatus 10c returns a completion response to the first ST apparatus 10a (S1256).

The first ST apparatus 10a, after receiving this completion response (S1256), sends a command to the effect “update pair status 131 to ‘PAIR’” to the second ST apparatus 10b (S1257), and, in addition, updates its own (first ST apparatus 10a) pair status 131 to “PAIR” (S1258).

The second ST apparatus 10b, which receives the command to the effect “update pair status 131 to ‘PAIR’” (S1257), updates its own pair status 131 to “PAIR” (S1259), and returns a completion response to the first ST apparatus 10a (S1260).

When the first ST apparatus 10a has received the completion response from the second ST apparatus 10b (S1260) and has completed updating its own (first ST apparatus 10a) pair status 131 (S1258), the first ST apparatus 10a ends the processing for updating the pair status 131 to “PAIR” (S1261).

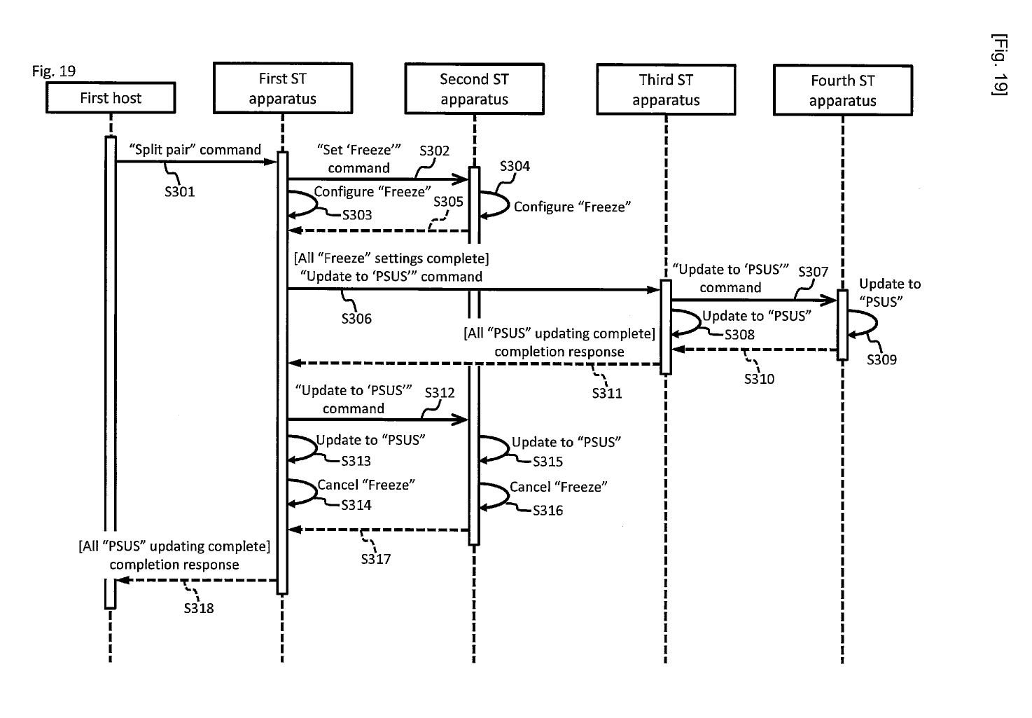

FIG. 19 is a sequence chart showing an example of processing relative to the “split pair” command. This processing is executed mainly by the pair splitting part 66.

The first ST apparatus 10a, upon receiving a “split pair” command from the first host 14a (S301), sends a “set ‘Freeze’” command to the second ST apparatus 10b (S302), and, in addition, configures “Freeze” in itself (first ST apparatus 10a) (S303).

The second ST apparatus 10b, which receives the “set ‘Freeze’” command from the first ST apparatus 10a (S302), configures “Freeze” in itself (second ST apparatus 10b) (S304) and returns a completion response to the first ST apparatus 10a (S305).

When the first ST apparatus 10a has completed configuring its own (first ST apparatus 10a) “Freeze” (S303) and has received the completion response from the second ST apparatus 10b (S305), the first ST apparatus 10a sends the third ST apparatus 10c a command to the effect “update pair status 131 to ‘PSUS’” (S306) and waits for a completion response (S311).

The third ST apparatus 10c, which receives the command to the effect “update pair status 131 to ‘PSUS’” from the first ST apparatus 10a (S306), sends the fourth ST apparatus 10d a command to the effect “update pair status 131 to ‘PSUS’” (S307), and, in addition, updates its own (third ST apparatus 10c) pair status 131 to “PSUS” (S308).

The fourth ST apparatus 10d, which receives the command to the effect “update pair status 131 to ‘PSUS’” from the third ST apparatus 10c, updates its own pair status 131 to “PSUS” and returns a completion response (S310).

When the third ST apparatus 10c has completed updating its own (third ST apparatus 10c) pair status 131 (S308) and has received the completion response from the fourth ST apparatus 10d (S310), the third ST apparatus 10c returns a completion response to the first ST apparatus 10a (S311).

The first ST apparatus 10a, upon receiving the completion response from the third ST apparatus 10c (S311), sends the second ST apparatus 10b a command to the effect “update pair status 131 to ‘PSUS’” (S312) and executes the processing of Steps S313 and S314 without waiting for a completion response thereto. The processing of Steps S313 and S314 is as follows. The first ST apparatus 10a updates its own (first ST apparatus 10a) pair status 131 to “PSUS” (S313), and cancels its own (first ST apparatus 10a) “Freeze” setting (S314).

The second ST apparatus 10b, which receives the command to the effect “update pair status 131 ‘PSUS’” from the first ST apparatus 10a (S312), updates its own (second ST apparatus 10b) pair status 131 to “PSUS” (S315), and cancels its own (second ST apparatus 10b) “Freeze” setting (S316). Then, the second ST apparatus 10b returns a completion response to the first ST apparatus 10a (S317).

When the first ST apparatus 10a has completed updating its own (first ST apparatus 10a) pair status 131 (S313 and S314) and has received the completion response from the second ST apparatus 10b (S317), the first ST apparatus 10a returns a completion response to the first host 14a (S318).

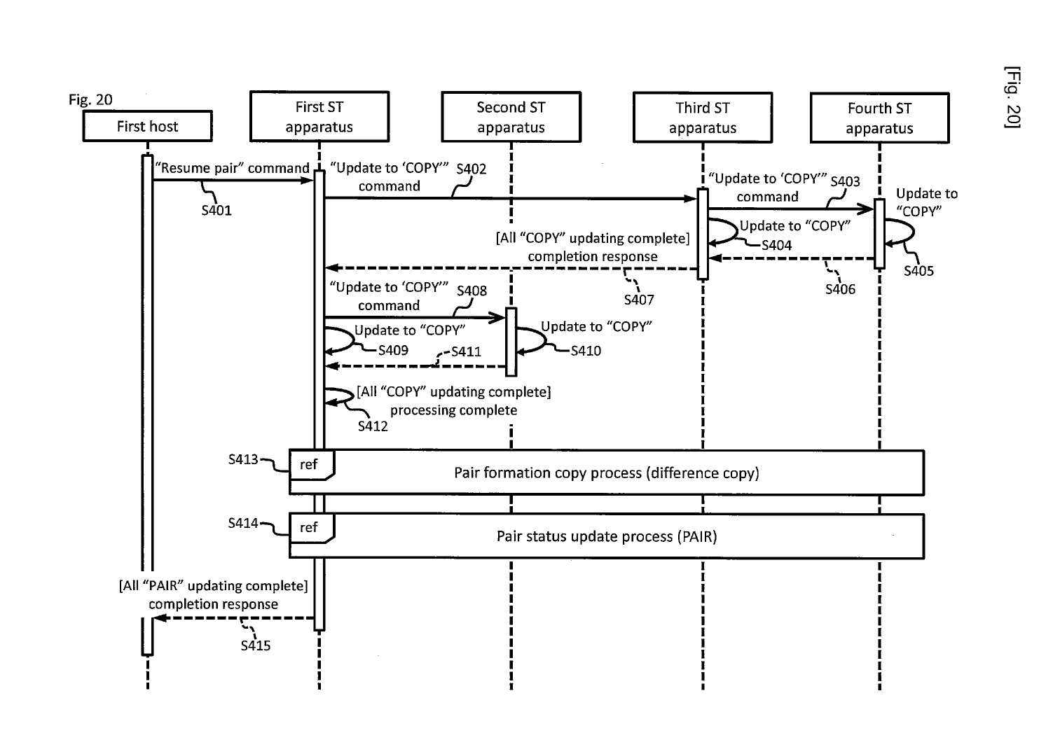

FIG. 20 is a sequence chart showing an example of processing relative to the “resume pair” command. This processing is executed mainly by the pair resuming part 70.

The first ST apparatus 10a, upon receiving a “resume pair” command from the first host 14a (S401), sends the third ST apparatus 10c a command to the effect “update pair status 131 to ‘COPY’” (S402), and waits for the completion response with respect to this command (S407).

The third ST apparatus 10c, which receives the command to the effect “update pair status 131 to ‘COPY’” from the first ST apparatus 10a (S402), sends the fourth ST apparatus 10d a command to the effect “update pair status 131 to ‘COPY’” (S403), and, in addition, updates its own (third ST apparatus 10c) pair status 131 to “COPY” (S404).

The fourth ST apparatus 10d, which receives the command to the effect “update pair status 131 to ‘COPY’” from the third ST apparatus 10c (S403), updates its own (fourth ST apparatus 10d) pair status 131 to “COPY” (S405), and returns a completion response to the third ST apparatus 10c (S406).

When the third ST apparatus 10c has completed updating its own (third ST apparatus 10c) pair status 131 (S404) and has received the completion response from the fourth ST apparatus 10d (S406), the third ST apparatus 10c returns a completion response to the first ST apparatus 10a (S407).

The first ST apparatus 10a, upon receiving the completion response from the third ST apparatus 10c (S407), sends the second ST apparatus a command to the effect “update pair status 131 to ‘COPY’” (S408), and, in addition, updates its own (first ST apparatus 10a) pair status 131 to “COPY” (S409).

The second ST apparatus 10b, which receives the command to the effect “update pair status 131 to ‘COPY’” from the first ST apparatus 10a, updates its own (second ST apparatus 10b) pair status 131 to “COPY” (S410), and returns a completion response to the first ST apparatus 10a (S410).

When the first ST apparatus 10a has completed updating its own (first ST apparatus 10a) pair status 131 (S409) and has received the completion response from the second ST apparatus 10b (S410) (S512), the first ST apparatus 10a executes pair formation copy processing for the difference data (S413). This pair formation copy processing differs from the processing shown in FIG. 17 in that only the updated data (difference data) in the primary virtual VOL 12a subsequent to splitting the pair is remote copied to the secondary virtual VOL 12b. However, since the subsequent processing is substantially the same as the processing shown in FIG. 17, an explanation thereof will be omitted here.

The first ST apparatus 10a, upon completing the processing of Step S413, executes the process for updating the pair status 131 to “PAIR” (S414). The process for updating the pair status 131 to “PAIR” is substantially the same as the processing shown in FIG. 18, and as such, an explanation thereof will be omitted here.

The first ST apparatus 10a, upon completing the processing of Step S414, returns a completion response to the first host 14a (S415).

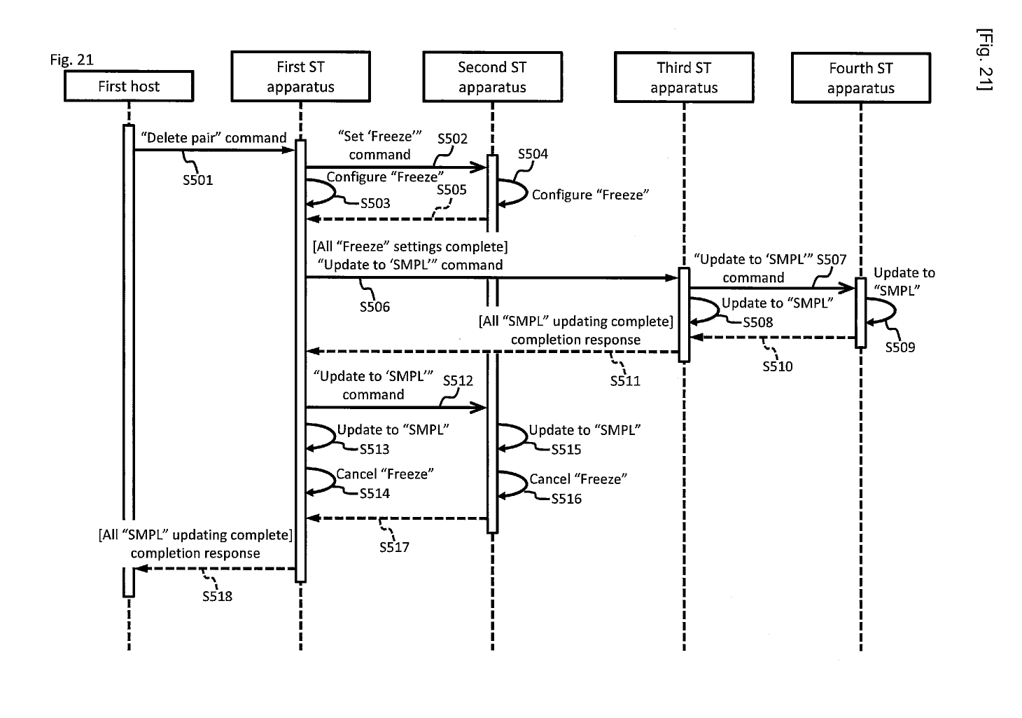

FIG. 21 is a processing sequence chart showing an example of processing relative to the “delete pair” command. This processing is executed mainly by the pair deleting part 67.

The first ST apparatus 10a, upon receiving a “delete pair” command from the first host 14a (S501), sends the second ST apparatus 10b a “set ‘Freeze’” command (S502), and, in addition, configures “Freeze” in itself (first ST apparatus 10a) (S503).

The second ST apparatus 10b, which receives the “set ‘Freeze’” command from the first ST apparatus 10a (S502), configures “Freeze” in itself (second ST apparatus 10b) (S504), and returns a completion response to the first ST apparatus 10a (S505).

When the first ST apparatus 10a has completed configuring its own (first ST apparatus 10a) “Freeze” (S503) and has received the completion response from the second ST apparatus 10b (S505), the first ST apparatus 10a sends the third ST apparatus 10c a command to the effect “update pair status 131 to ‘SMPL’” (S506).

The third ST apparatus 10c, which receives the command to the effect “update pair status 131 to ‘SMPL’” from the first ST apparatus 10a, sends the fourth ST apparatus 10d a command to the effect “set pair status 131 to ‘SMPL’” (S507), and, in addition, updates its own (third ST apparatus 10c) pair status 131 to “SMPL” (S508).

When the third ST apparatus 10c has completed updating its own (third ST apparatus 10c) pair status 131 (S508) and has received the completion response from the fourth ST apparatus 10d (S510), the third ST apparatus 10c returns a completion response to the first ST apparatus 10a (S511).

The first ST apparatus 10a, upon receiving the completion response from the third ST apparatus 10c (S511), sends the second ST apparatus 10b a command to the effect “update pair status 131 to ‘SMPL’” (S512), and executes the following Steps S513 and S514 without waiting for the completion response thereto. The processing of Steps S513 and S514 is as follows. The first ST apparatus 10a updates its own (first ST apparatus 10a) pair status 131 to “SMPL” (S513), and cancels its own (first ST apparatus 10a) “Freeze” setting (S514).

The second ST apparatus 10b, which receives the command to the effect “update pair status 131 ‘SMPL’” from the first ST apparatus 10a (S512), updates its own (second ST apparatus 10b) pair status 131 to “SMPL” (S515), and cancels its own (second ST apparatus 10b) “Freeze” setting (S516). Then, the second ST apparatus 10b returns a completion response to the first ST apparatus 10a (S517).

When the first ST apparatus 10a has completed updating its own (first ST apparatus 10a) pair status 131 (S513 and S514) and has received the completion response from the second ST apparatus 10b (S517), the first ST apparatus 10a returns a completion response to the first host 14a (S518).

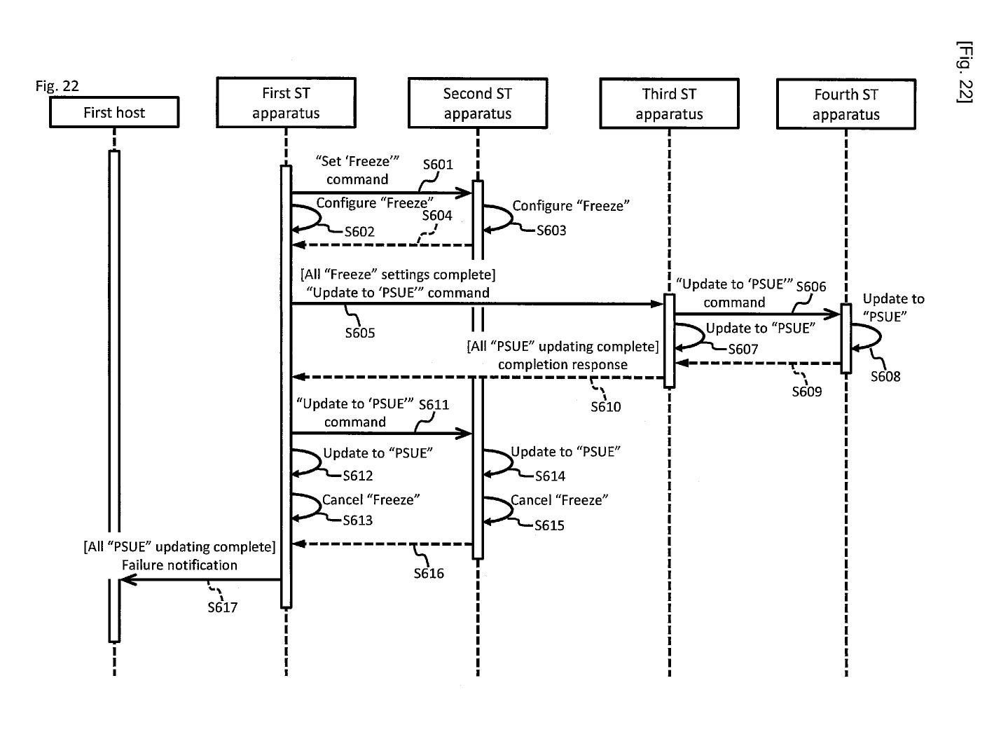

FIG. 22 is a sequence chart showing an example of failure suspension processing. This processing is executed mainly by the failure suspending part 68.

For example, when the first ST apparatus 10a detects a failure in either the third ST apparatus 10c or the fourth ST apparatus 10d, the first ST apparatus 10a sends the second ST apparatus 10b a “set ‘Freeze’” command (S601), and, in addition, configures “Freeze” in itself (first ST apparatus 10a) (S602).

The second ST apparatus 10b, which receives the “set ‘Freeze’” command from the first ST apparatus 10a, configures “Freeze” in itself (second ST apparatus 10b) (S603), and returns a completion response to the first ST apparatus 10a (S604).

When the first ST apparatus 10a has completed configuring its own (first ST apparatus 10a) “Freeze” (S602) and has received the completion response from the second ST apparatus 10b (S604), the first ST apparatus 10a sends the third ST apparatus 10c a command to the effect “update pair status 131 to ‘PSUE’” (S605) and waits for a completion response with respect to this command (S610).

The third ST apparatus 10c, which receives the command to the effect “update pair status 131 to ‘PSUE’” from the first ST apparatus 10a (S605), sends the fourth ST apparatus 10d a command to the effect “set pair status 131 to ‘PSUE’” (S606), and, in addition, updates its own (third ST apparatus 10c) pair status 131 to “PSUE” (S607).

The fourth ST apparatus 10d, which has received the command to the effect “update pair status 131 to ‘PSUE’” from the third ST apparatus 10c (S606), updates its own pair status 131 to “PSUE” (S608) and returns a completion response (S609).

When the third ST apparatus 10c has completed updating its own (third ST apparatus 10c) pair status 131 to “PSUE” (S607) and has received the completion response from the fourth ST apparatus 10d (S609), the third ST apparatus 10c returns a completion response to the first ST apparatus 10a (S610).

When the first ST apparatus 10a has received the completion response from the third ST apparatus 10c (S610), the first ST apparatus 10a sends the second ST apparatus 10b a command to the effect “update pair status 131 to ‘PSUE’” (S611), and executes the following Steps S612 and S613 without waiting for the completion response thereto (S616). The processing of Steps S612 and S613 is as follows. The first ST apparatus 10a updates its own (first ST apparatus 10a) pair status 131 to “PSUE” (S612), and cancels its own (first ST apparatus 10a) “Freeze” setting (S613).

The second ST apparatus 10b, which receives the command to the effect “update pair status 131 ‘PSUE’” from the first ST apparatus 10a (S611), updates its own (second ST apparatus 10b) pair status 131 to “PSUE” (S614), and cancels its own (second ST apparatus 10b) “Freeze” setting (S615). Then, the second ST apparatus 10b returns a completion response to the first ST apparatus 10a (S616).

When the first ST apparatus 10a has completed updating its own (first ST apparatus 10a) pair status 131 (S612 and S613) and has received the completion response from the second ST apparatus 10b (S616), the first ST apparatus 10a sends a notification to the first host 14a to the effect that a failure has occurred (S617).

Example 1, for example, has the following effects.

(1) The data stored in the primary virtual VOL 12a, which comprises multiple logical VOLs 20, and the data stored in the secondary virtual VOL 12b, which comprises multiple logical VOLs 20, can be synchronized. In accordance with this, even when a failure has occurred in the one virtual VOL 102, the other virtual VOL 12 is able to deal with a request from the host 14. That is, the fault tolerance of the entire storage system 1 can be heightened.

(2) Since a primary virtual VOL 12a and a secondary virtual VOL 12b are able to be realized by being respectively distributed among the multiple storage apparatuses 10a, 10b. 10c, and 10d, the access load on the storage system 1 can be distributed.

(3) When splitting a primary virtual VOL 12a and a secondary virtual VOL 12b pair, the data sequence between the primary virtual VOL 12a and the secondary virtual VOL 12b can be maintained by configuring a “Freeze” as described hereinabove. That is, consistent data can be created in the secondary virtual VOL 12b. For example, executing pair splitting in conjunction with the host 14 application makes it possible to create data in the secondary virtual VOL 12b in accordance with an appropriate execution timing of the application. In addition, the application is able to resume operation immediately after pair-splitting has been executed.

### Example 2

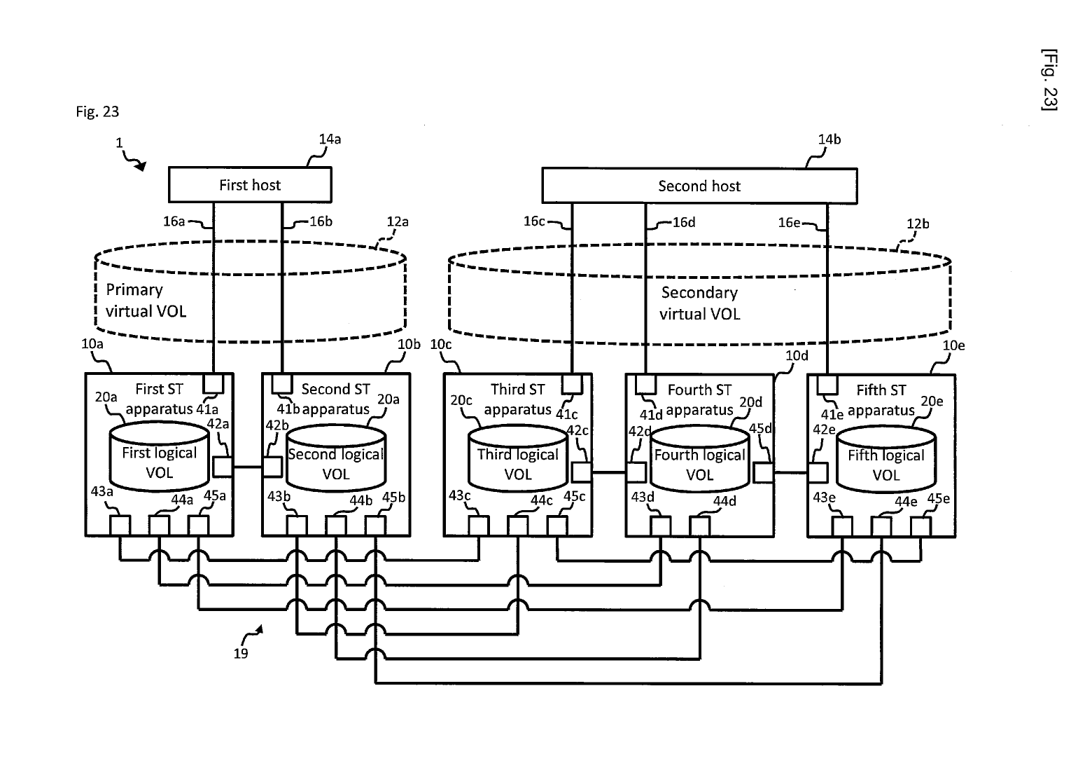

FIG. 23 is a diagram showing the system configuration of a storage system 1 related to Example 2. The main point of difference with the storage system 1 related to FIG. 1 is that the secondary virtual VOL 12b is configured from three storage apparatuses, i.e., a third ST apparatus 10c, a fourth ST apparatus 10d, and a fifth ST apparatus 10e. The same reference numerals will be assigned below to elements, which are the same as those of Example 1, and explanations of these same elements will be omitted.

Each ST apparatus 10 is coupled to other ST apparatus 10 via a cable 19, which enables two-way data communications. A second host 14b apparatus is coupled via a cable 16e to a fifth ST apparatus 10e in addition to the third ST apparatus 10c and the fourth ST apparatus 10d.

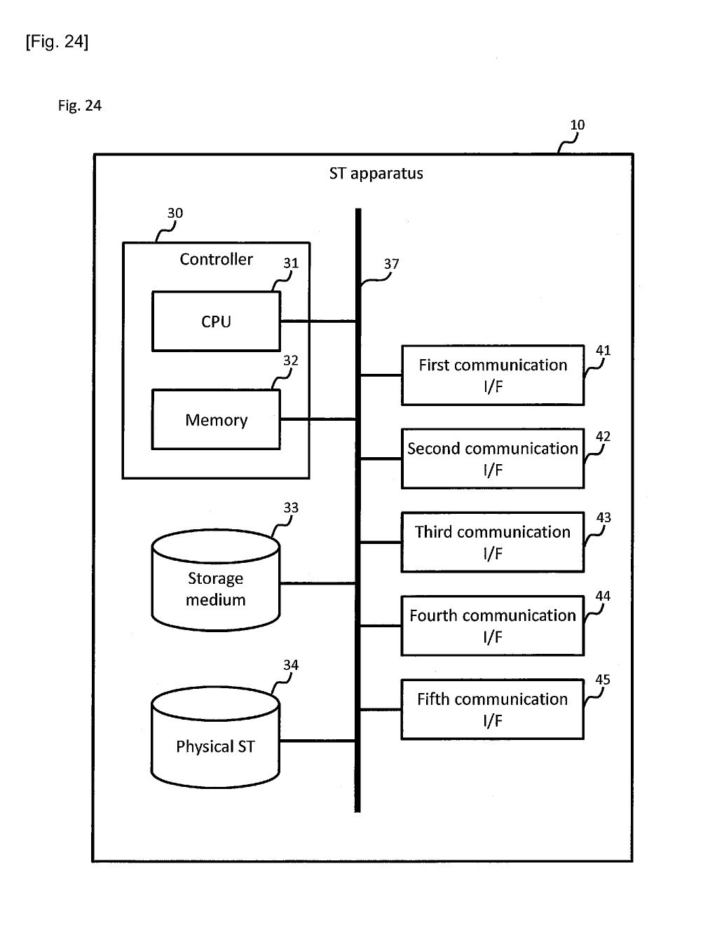

FIG. 24 is a diagram showing the hardware configuration of the ST apparatus 10 related to Example 2. The main point of difference with the hardware configuration related to FIG. 3 is that one communication I/F (that is, a Port) has been added. Other than this, the explanation is the same as that given using FIG. 3.

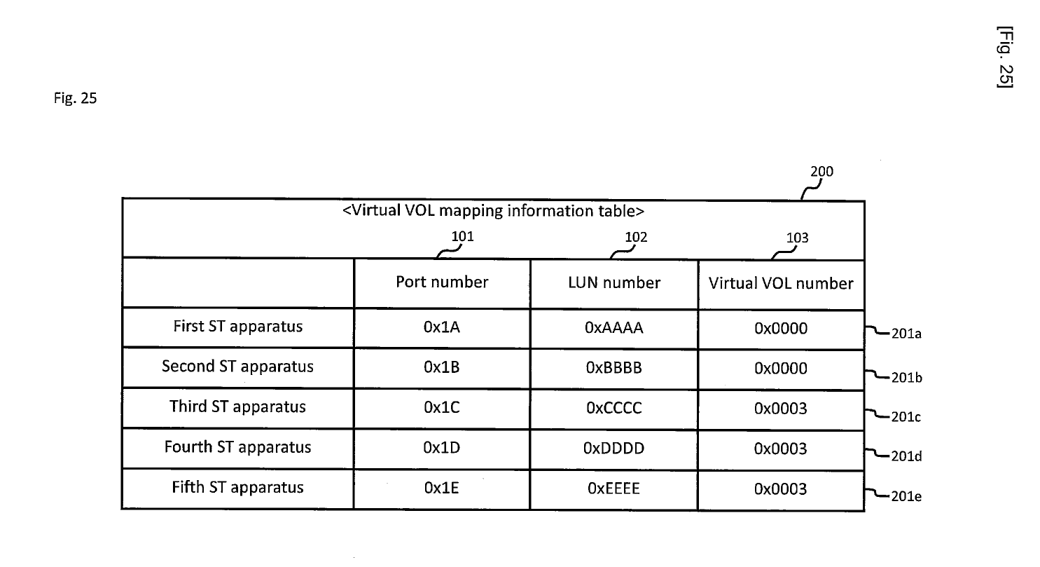

FIG. 25 is a diagram showing an example of the data configuration of a virtual VOL mapping information table 200. The point of difference with the virtual VOL mapping information table 200 related to FIG. 5 is that virtual VOL mapping information 201e related to the fifth ST apparatus 10e has been added. Other than this, the explanation is the same as that given using FIG. 5.

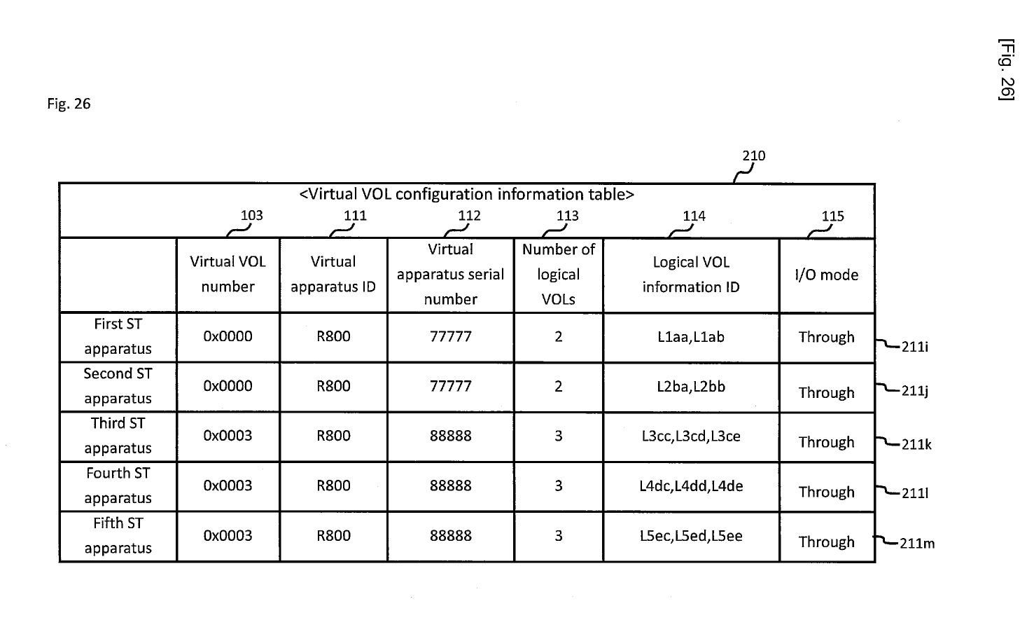

FIG. 26 is a diagram showing an example of the data configuration of a virtual VOL configuration information table 210. There are two main points of difference with the virtual VOL configuration information table 210 related to FIG. 6. The first point of difference is that virtual VOL mapping information 211m related to the fifth ST apparatus 10e has been added. The second point of difference is that since the secondary virtual VOL 12b is configured from three logical VOLs 20, the number of logical VOLs 113 of the third through the fifth ST apparatuses is “3”, and there are three logical VOL information IDs 114 corresponding thereto. Other than this, the explanation is the same as that given using FIG. 6.

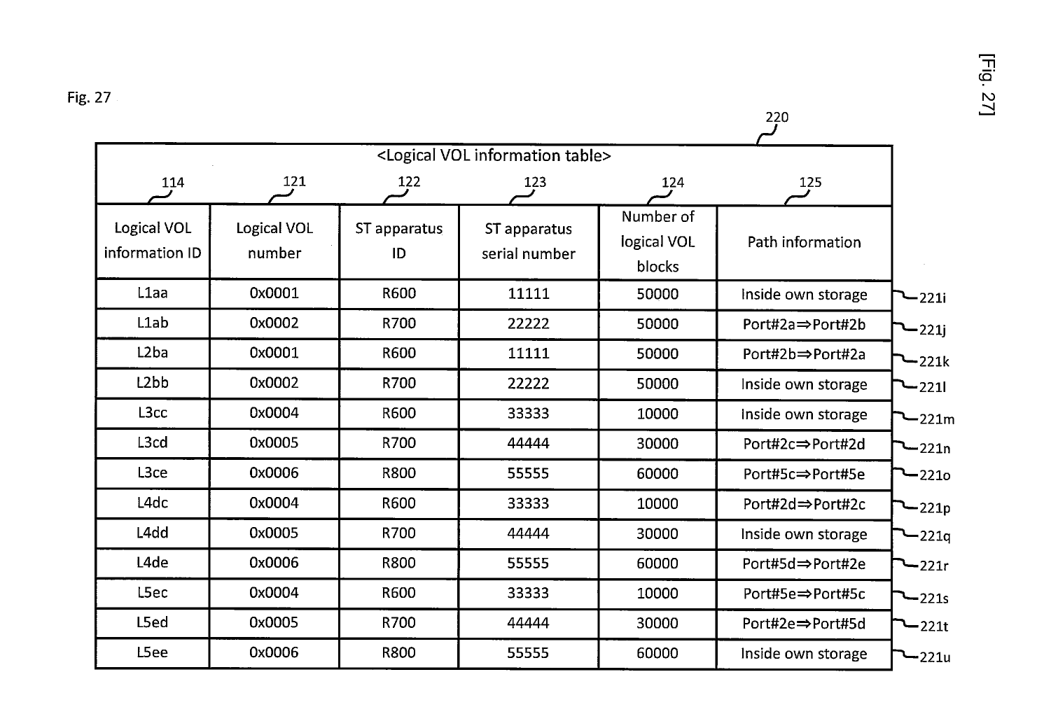

FIG. 27 is a diagram showing an example of the data configuration of a logical VOL information table 220. The main point of difference with the logical VOL information table 220 related to FIG. 7 is that logical VOL information 221 has been added to deal with the fact that the secondary virtual VOL 12b is configured using three logical VOLs 20. Other than this, the explanation is the same as that given using FIG. 7.

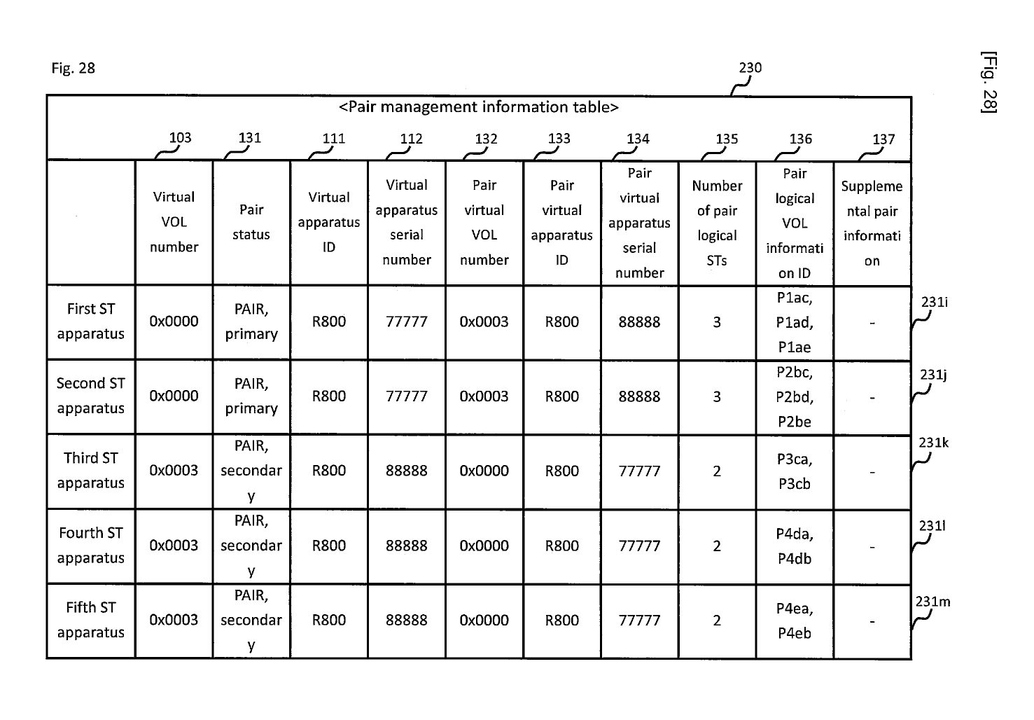

FIG. 28 is a diagram showing an example of the data configuration of a pair management information table 230. There are two main points of difference with the pair management information table 230 related to FIG. 8. The first point of difference is that virtual VOL configuration information 211m related to the fifth ST apparatus 10e has been added. The second point of difference is that, since the secondary virtual VOL 12b is configured from three logical VOLs 20, the number of pair logical VOLs 135 of the first ST apparatus 10a and the second ST apparatus 10b is “3”, and there are three pair logical VOL information IDs 136 corresponding thereto. Other than this, the explanation is the same as that given using FIG. 8.

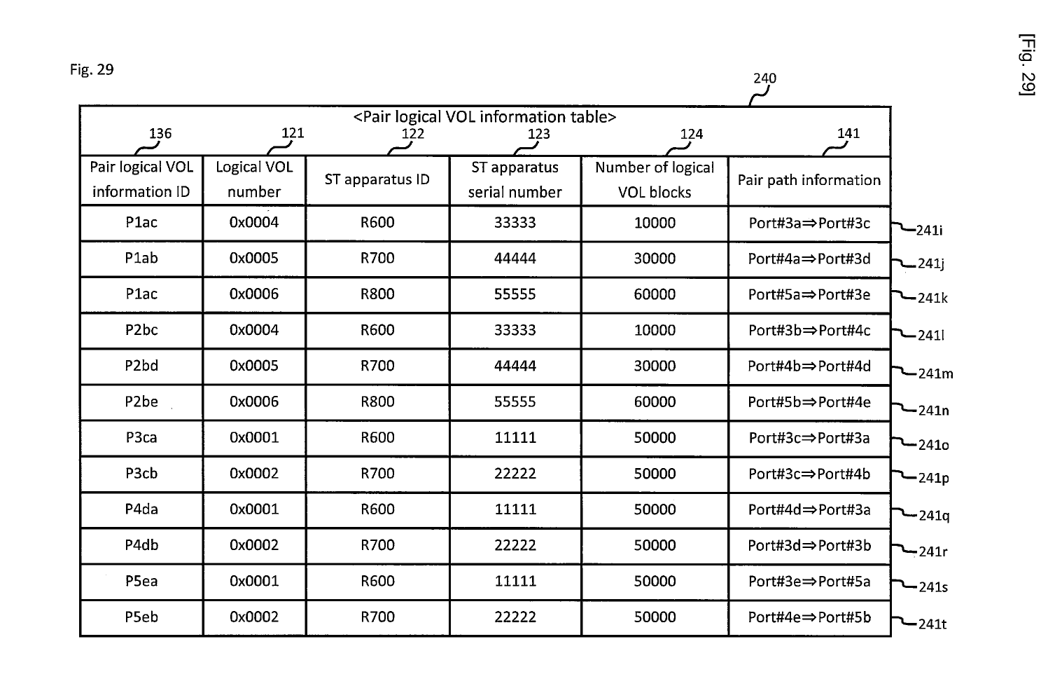

FIG. 29 is a diagram showing an example of the data configuration of a pair logical VOL information table 240. The main point of difference with the pair logical VOL information table 240 related to FIG. 9 is that pair logical VOL information 241 has been added to deal with the fact that the secondary virtual VOL 12b is configured using three logical VOLs 20. Other than this, the explanation is the same as that given using FIG. 9.

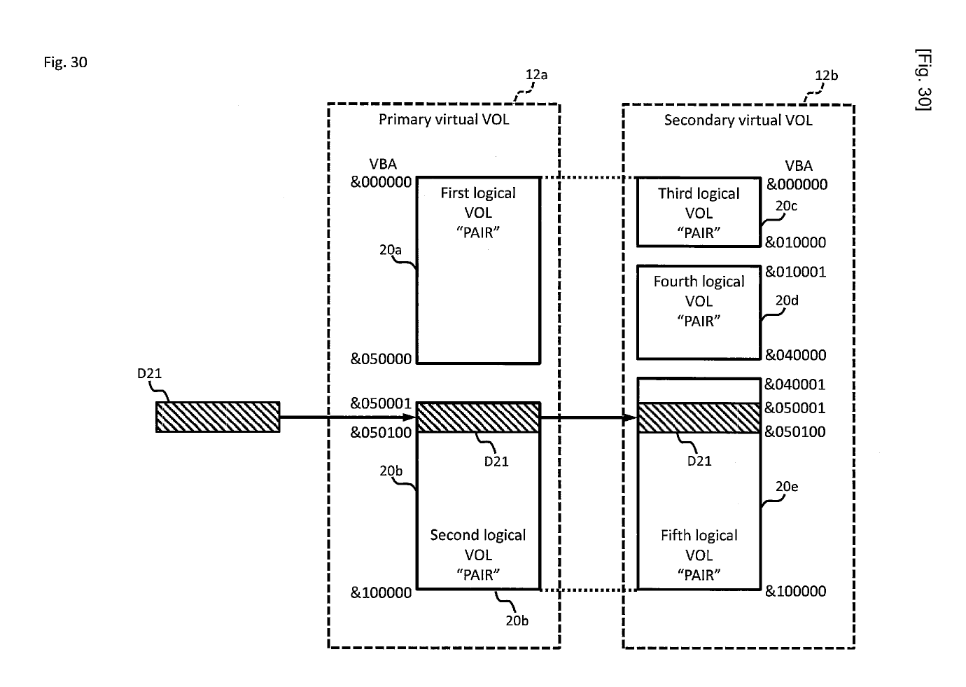

FIG. 30 is a schematic diagram for illustrating an inter-pair RCP in Example 2. The primary virtual VOL 12a comprises a first logical VOL 20a and a second logical VOL 20b. The corresponding relationship between the VBA of the primary virtual VOL 12a and the LBA of the first logical VOL 20a and the second logical VOL 20b is the same as the corresponding relationship related to FIG. 2.

The secondary virtual VOL 12b comprises a third logical VOL 20c, a fourth logical VOL 20d, and a fifth logical VOL 20e. The VBA “000000 through 010000” of the secondary virtual VOL 12b is associated with the LBA “000000 through 0100000” of the third logical VOL 20c. The VBA “010001 through 040000” of the secondary virtual VOL 12b is associated with the LBA “000000 through 030000” of the fourth logical VOL 20d. The VBA “040001 through 100000” of the secondary virtual VOL 12b is associated with the LBA “000000 through 060000” of the fifth logical VOL 20e.

In the case of a configuration such as this, the data written to the second logical VOL 20b is always written to the fifth logical VOL 20e. This is because the size of the LBA of the second logical VOL 20b is smaller than the size of the LBA of the fifth logical VOL 20e. Therefore, there is no need for the second ST apparatus 10b to make a determination as to which of the logical VOLs 20 comprising the secondary virtual VOL 12b to write the data written in the second logical VOL 20b.

For example, as shown in FIG. 30, in a case where a command for writing data D21 to the VBA “050001 through 050100” of the primary virtual VOL 12a has been received, this data D21 is written to the LBA “000000 through 000100” of the second logical VOL 20b of the second ST apparatus 10b. Then, the second ST apparatus 10b can send a “RCP” command to the fifth logical VOL 20e without making a determination as to which of the third logical VOL 20c through the fifth logical VOL 20e the write should be performed.

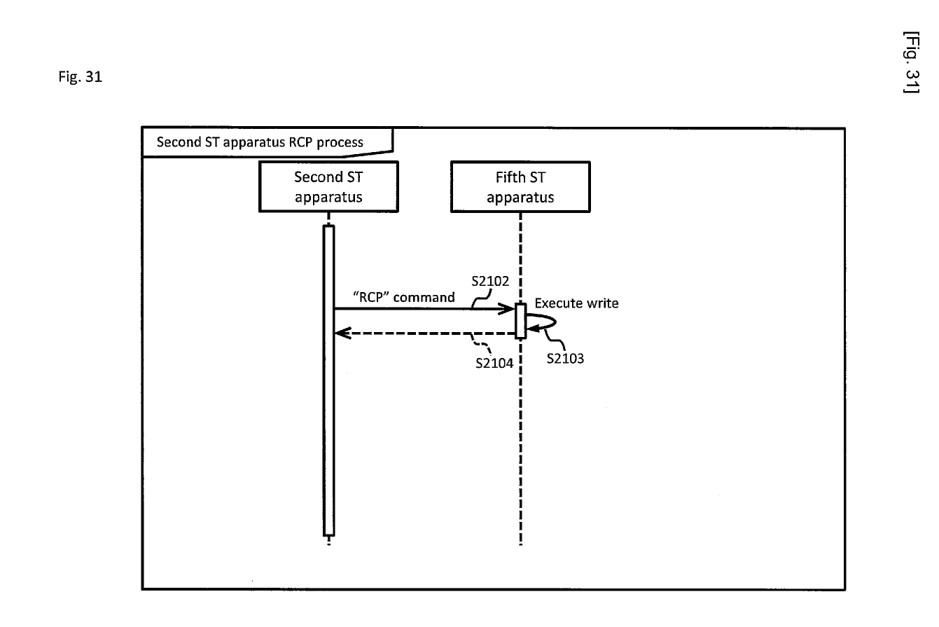

FIG. 31 is a sequence chart showing an example of the RCP processing of the second ST apparatus 10b. This processing is executed mainly as part of the processing of the writing part 61.

In the case of the configuration shown in FIG. 30, it is possible to replace the processing shown in FIG. 13 with the processing shown in this FIG. 31. That is, the second ST apparatus 10b sends a “RCP” command to the fifth ST apparatus 10e (S2102) without performing the determinations of S1101 and S1105 shown in FIG. 13. The fifth ST apparatus 10e, which receives the “RCP” command (S2102), writes the data received together with this “RCP” command to the LBA of its own fifth logical VOL 20e (S2103), and returns a completion response (S2104).

Therefore, in the case of the configuration shown in FIG. 30, it is possible to replace Step S105 of the “write processing” shown in FIG. 11, Step S1232 of the “pair formation copy processing” shown in FIG. 17, and Step S513 of the “pair resumption processing” shown in FIG. 20 with the processing of this FIG. 31.

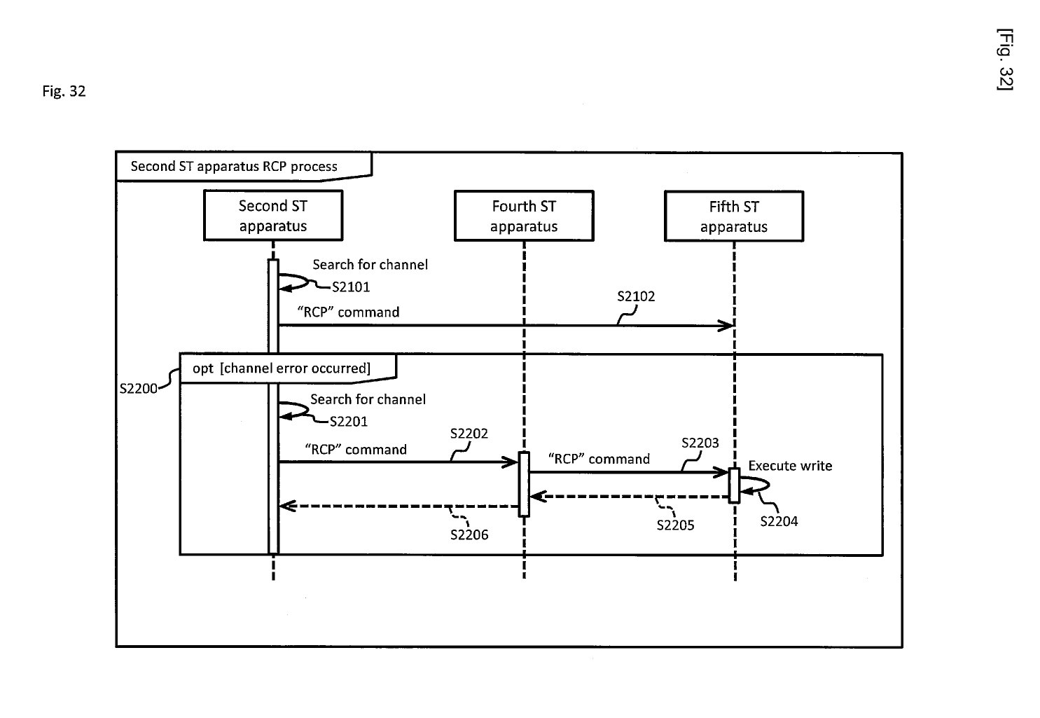

FIG. 32 is a sequence chart showing an example of processing in a case where a failure has occurred on the RCP path. This processing is executed mainly as a part of the processing of the writing part 61.

For example, the second ST apparatus 10b references the pair logical VOL information table 240 of FIG. 29 and searches for the channel, which directly links itself (second ST apparatus 10b) to the fifth ST apparatus 10e. By referencing the pair logical VOL information 241n here, the second ST apparatus 10b is able to identify the fact that its own (second ST apparatus 10b) Port #5b is directly linked to Port #4e of the fifth ST apparatus 10e.

Then, it is supposed that when the second ST apparatus 10b sends the “RCP” command to the fifth ST apparatus 10e via this identified channel (S2102), and this transmission fails (S2200: opt: error). In accordance with this, the second ST apparatus 10b executes the processing of the following Steps S2201 through S2206.

That is, the second ST apparatus 10b references the logical VOL information table 220 and the pair logical VOL information table 240 of FIG. 29, and searches for another channel linking itself (second ST apparatus 10b) to the fifth ST apparatus 10e (S2201).

At this point, for example, the second ST apparatus 10b searches for an alternative channel enabling access to the fifth ST apparatus 10e via a ST apparatus 10 other than the fifth ST apparatus 10e comprising the secondary virtual VOL 12b. For example, the second ST apparatus 10b, by referring to the pair logical VOL information 241m shown in FIG. 29, can identify the fact that Port #4e of the fourth ST apparatus 10d is linked to its own Port #5b. In addition, by referring to the logical VOL information 221r shown in FIG. 27, for example, the second ST apparatus 10b can identify the fact that Port #2e of the fifth ST apparatus 10e is linked to Port #5d of the fourth ST apparatus 10d. In accordance with this, the second ST apparatus 10b is able to identify an alternative channel, which enables access to the fifth ST apparatus 10e via the fourth ST apparatus 10d.

Then, the second ST apparatus 10b sends a “RCP” command to the fourth ST apparatus 10d (S2202). The fourth ST apparatus 10d, which receives this “RCP” command, transfers the “RCP” command to the fifth ST apparatus 10e (S2203). The fifth ST apparatus 10e, which receives this “RCP” command, writes the data to the fifth logical VOL 20e (S2204) and returns a completion response to the fourth ST apparatus 10d (S2205). The fourth ST apparatus 10d, which receives this completion response, returns a completion response to the second ST apparatus 10b (S2206).

This makes it possible to execute a RCP using a different alternative channel in a case where some sort of failure has occurred in the channel directly linking the second ST apparatus 10b to the fifth ST apparatus 10e.

Furthermore, the second ST apparatus 10b may search for an alternative channel other than the one described hereinabove. For example, the second ST apparatus 10b searches for an alternative channel, which will enable access to the fifth ST apparatus 10e via another ST apparatus 10 comprising the primary virtual VOL 12a. For example, the second ST apparatus 10b can identify the fact that Port #2a of the first ST apparatus 10a is linked to its own Port #2b by referring to the logical VOL information 221k shown in FIG. 27. In addition, the second ST apparatus 10b, for example, can identify the fact that Port #3e of the fifth ST apparatus 10e is linked to the Port #5a of the first ST apparatus 10a by referring to the pair logical VOL information 241k shown in FIG. 29. This makes it possible for the second ST apparatus 10b to identify an alternative channel, which enables access to the fifth ST apparatus 10e via the first ST apparatus 10a.

In a case where the transmission of the “RCP” command also fails on the above-mentioned alternative channel, yet another alternative channel may be searched out.

Example 2, for example, has the following effects.

(1) In a case where an LBA of a certain logical VOL 20 comprising the primary virtual VOL 12a is included in an LBA of a certain logical VOL 20 comprising the secondary virtual VOL 12b, there is no need to make a determination as to which logical VOL 20 of the secondary virtual VOL 12b a remote copy of the data written in this certain logical VOL 20 of the primary virtual VOL 12a should be performed. This makes it possible to shorten the processing time related to this determination.

(2) In a case where the RCP fails when remote copying data from the primary virtual VOL 12a to the secondary virtual VOL 12b, it is possible to execute this RCP using a different communication channel. That is, it is possible to execute the RCP by bypassing the communication channel in which the failure occurred. This makes it possible to heighten the fault tolerance of the entire storage system 1.

### Example 3

In Example 3, preprocessing of the above-described pair formation preparation process (S202) will be explained. The preprocessing forms a RCP pair between a virtual apparatus, which comprises a primary virtual VOL 12a, and a virtual apparatus, which comprises a secondary virtual VOL 12b. That is, the above-described pair formation preparation process (S202) is executed subsequent to a RCP pair having been formed between a primary virtual VOL 12a and a second virtual VOL 12b.

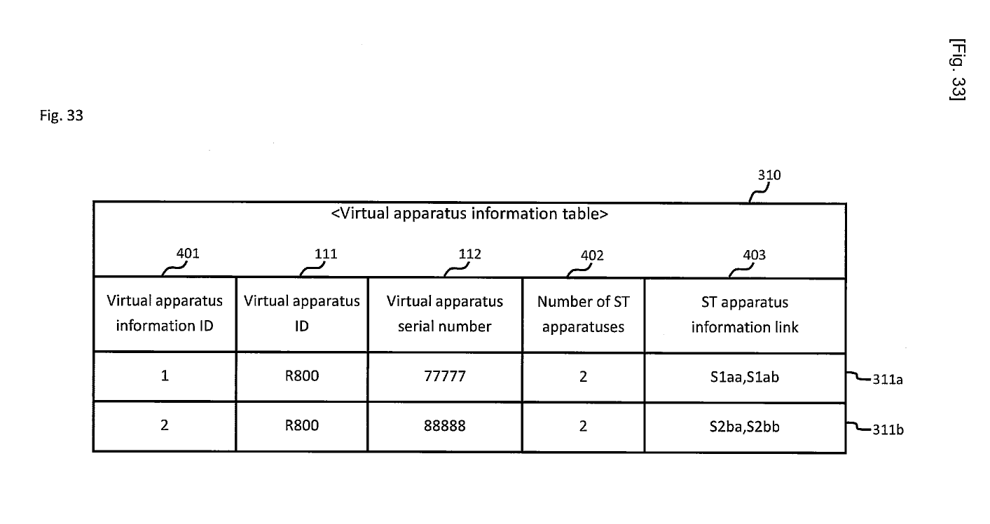

FIG. 33 is a diagram showing an example of the data configuration of a virtual apparatus information table 310. The virtual apparatus is a virtualized apparatus comprising a virtual VOL 12. The virtual apparatus information table 310 is stored in each ST apparatus 10 comprising a virtual apparatus. The virtual apparatus information table 310 comprises multiple pieces of virtual apparatus information 311. The virtual apparatus information 311 comprises a virtual apparatus information ID 401, a virtual apparatus ID 111, a virtual apparatus serial number 112, a number of ST apparatus 402, and a ST apparatus information link 403 as data items.

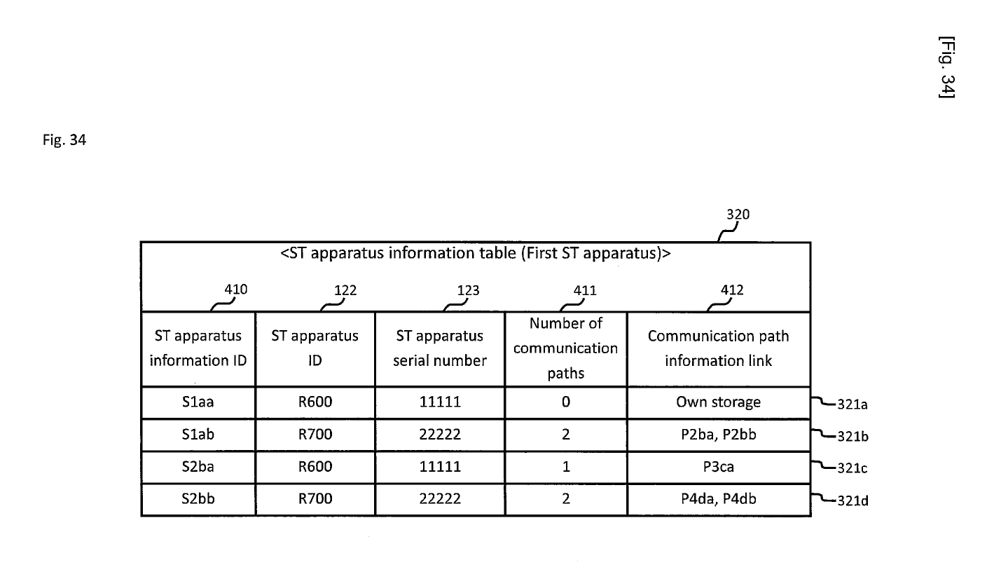

An ID for identifying the virtual apparatus information 311 is registered in the virtual apparatus information ID 401. The virtual apparatus ID 111 and the virtual apparatus serial number 112 are the same as those explained hereinabove. A number of ST apparatuses 10 comprising the virtual apparatus is registered in the number of ST apparatuses 402. A ST apparatus information ID 410 (refer to FIG. 34) for each ST apparatus 10 comprising either one, or two or more virtual apparatuses is registered in the ST apparatus information link 403.

For example, virtual apparatus information 311a shows the following. For the virtual apparatus having a virtual apparatus information ID 401 of “1”, the virtual apparatus ID 111 is “R800” and the virtual apparatus serial number 112 is “77777”. This virtual apparatus is configured from “two” ST apparatuses 10, and the ST apparatus information IDs 410 corresponding to the respective ST apparatuses 10 comprising the virtual apparatus are “S1aa” and “S1ab”.

FIG. 34 is a diagram showing an example of the data configuration of a ST apparatus information table 320. The ST apparatus information table 320 of FIG. 34 shows a relationship between the first ST apparatus 10a and other ST apparatuses 10. The ST apparatus information table 320 comprises multiple pieces of ST apparatus information 321. The ST apparatus information 321 comprises a ST apparatus information ID 410, a ST apparatus ID 122, a ST apparatus serial number 123, a number of communication paths 411, and a communication path information link 412 as data items.

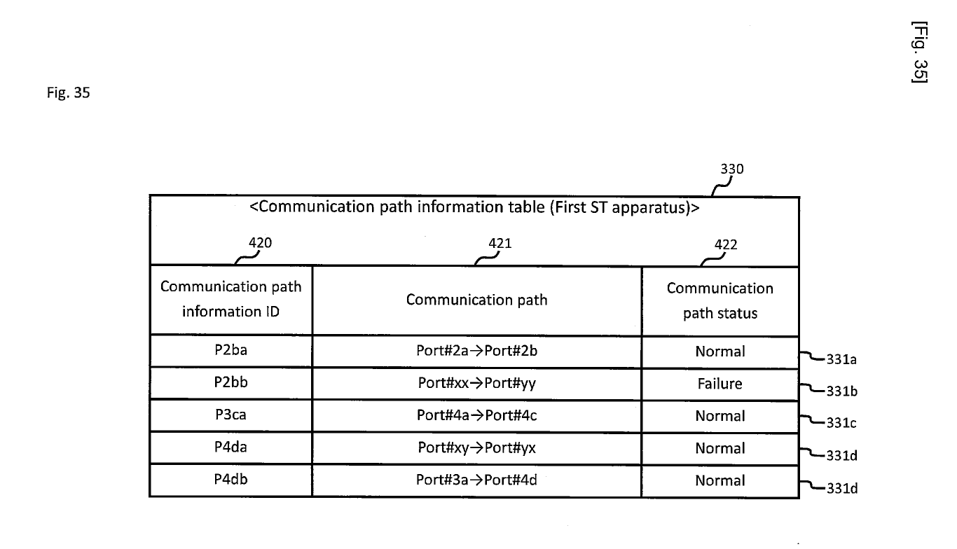

An ID for identifying the ST apparatus information 321 is registered in the ST apparatus information ID 410. The ST apparatus ID 122 and the ST apparatus serial number 123 are the same as those explained hereinabove. A number of communication paths, which connect the first ST apparatus 10a to another ST apparatus 10 corresponding to the ST apparatus information ID 410, is registered in the number of communication paths 411. A communication path information ID 420 (refer to FIG. 35) related to either one, or two or more communication paths, which connect the first ST apparatus 10a to another ST apparatus 10 corresponding to the ST apparatus information ID 410, is registered in the communication path information link 412.

For example, the ST apparatus information 321b shows the following. For the second ST apparatus 10b having a ST apparatus information ID 410 of “S1ab”, the ST apparatus ID 122 is “R700” and the ST apparatus serial number 123 is “22222”. The number of communication paths connecting the first ST apparatus 10a to the second ST apparatus 10b (“S1ab”) is “two”. The communication path information IDs 420 related to the two communication paths connecting the first ST apparatus 10a to the second ST apparatus 10b (“S1ab”) are “P2ba” and “P2bb”.

FIG. 35 is a diagram showing an example of the data configuration of a communication path information table 330. The communication path information table 330 of FIG. 35 shows information about a communication path, which connects the first ST apparatus 10a to another ST apparatus 10. The communication path information table 330 comprises multiple pieces of communication path information 331. The communication path information 331 comprises a communication path information ID 420, a communication path 421 and a communication path status 422 as data items.

An ID for identifying communication path information 331 is registered in the communication path information ID 420. A communication path, which connects the first ST apparatus 10a to another ST apparatus 10, is registered in the communication path 421. A communication status of the communication path 421 (for example, whether or not a failure has occurred) is registered in the communication path status 422.

For example, the ST apparatus information 331b shows the following. The communication path 421 having the communication path information ID 420 of “P2bb” is “Port #xx->Port #yy”, and a “failure” has occurred in this communication path.

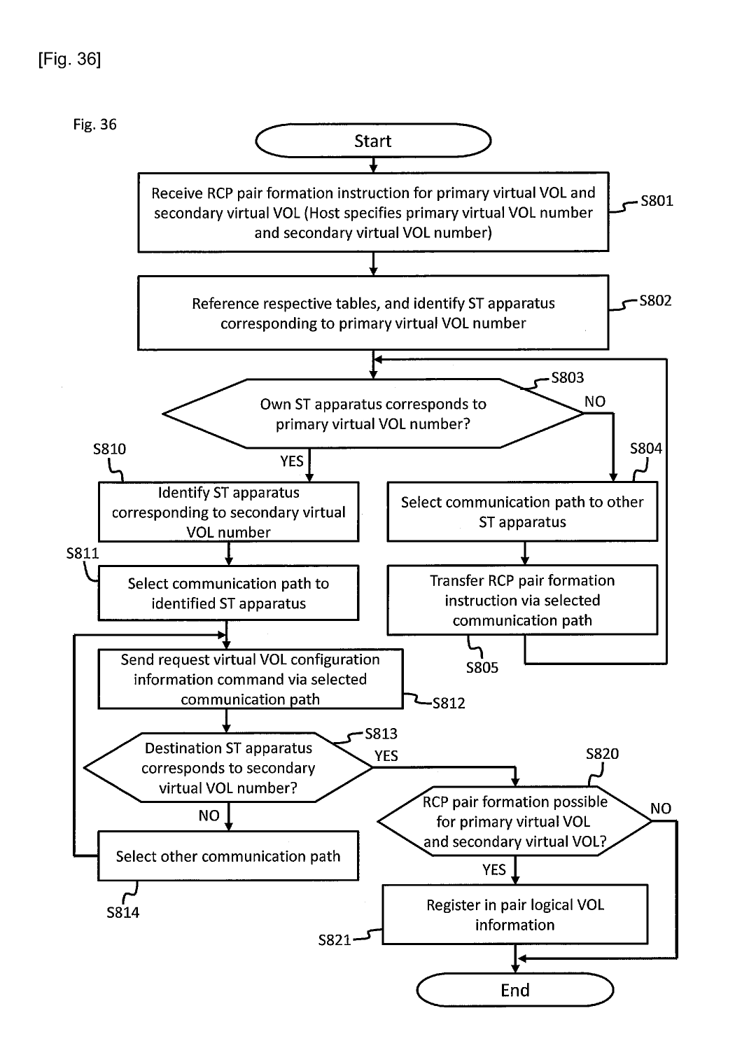

FIG. 36 is a flowchart showing a RCP pair formation process for a primary virtual VOL and a secondary virtual VOL.

The ST apparatus 10 receives a RCP pair formation instruction for a primary virtual VOL and a secondary virtual VOL from the host 14 (S801), and executes the following processing. The RCP pair formation instruction comprises a primary virtual VOL number, a primary virtual apparatus ID, and a primary virtual apparatus serial number of the preferred primary virtual VOL, and a secondary virtual VOL number, a secondary virtual apparatus ID, and a secondary virtual apparatus serial number of the preferred secondary virtual VOL.

The ST apparatus 10, which receives the pair formation instruction, references the virtual apparatus information table 310, the ST apparatus information table 320, and the communication path information table 330, identifies either one, or two or more ST apparatuses 10 corresponding to a primary virtual apparatus ID and a primary virtual apparatus serial number, and, in addition, identifies a communication path 421 for communicating with another ST apparatus 10 (S802). That is, the ST apparatus 10 identifies either one, or two or more ST apparatuses 10, which are capable of comprising the virtual VOL specified as the primary virtual VOL. In a case where a ST apparatus 10 corresponding to the primary virtual VOL is not able to be identified, the ST apparatus 10 may respond to the host 14 to that effect and end the relevant processing.

The ST apparatus 10, which receives the pair formation instruction, references the virtual VOL configuration information table 210 to determine whether or not it itself comprises a virtual VOL corresponding to the primary virtual VOL number, the primary virtual apparatus ID and the primary virtual apparatus serial number (S803). First, a case in which the determination in the relevant Step S803 is negative (S803: NO) will be explained below.

The ST apparatus 10 selects the either one, or two or more communication paths, which were identified in Step S802, and which are coupled to the other ST apparatus 10 capable of comprising the primary virtual VOL. Then, the ST apparatus 10 selects one communication path for which the communication path status 422 is “normal” from the selected one, or two or more communication paths (S804).

The ST apparatus 10 transfers the RCP pair formation instruction received in Step S801 to the identified other ST apparatus 10 via this selected communication path (S805). The ST apparatus 10, which receives the transfer, executes the processing from Step S803. In a case where this transfer fails, the ST apparatus 10 may return to Step S804 and select another communication path. The ST apparatus 10, which receives the transfer of Step S805, executes the processing of Step S803 and beyond. In accordance with this, the one ST apparatus 10 corresponding to the primary virtual VOL number receives the RCP pair formation instruction. Then, the determination result of Step S803 becomes affirmative for this ST apparatus 10.

Next, a case in which the determination in Step S803 is affirmative (S803: YES) will be explained below.

The ST apparatus 10 identified either one, or two or more ST apparatuses 10 capable of comprising the virtual VOL specified as the secondary virtual VOL (S810). This processing is substantially the same as the processing of Step S802 described above.

The ST apparatus 10 references the ST apparatus information table 320 and the communication path information table 330, and selects the either one, or two or more communication paths coupled to the other ST apparatus 10, which was identified in Step S810, and which corresponds to the secondary virtual VOL. Then, the ST apparatus 10 selects one communication path for which the communication path status 422 is “normal” from the selected one, or two or more communication paths (S811).

The ST apparatus 10 sends a “request virtual VOL configuration information” command to the other ST apparatus 10 via the selected communication path (S812). Then, the ST apparatus 10 receives a response to this command. Based on this response, the ST apparatus 10 determines whether or not command-destination ST apparatus 10 corresponds to the secondary virtual VOL number (S813). In a case where the determination in Step S813 is affirmative, for example the virtual VOL configuration information 211 and the logical VOL information 221 stored in the command-destination ST apparatus 10 is included in this response.

In a case where the determination in Step S813 is negative (S813: NO), the ST apparatus 10 selects one other “normal” communication path from the either one, or two or more communication paths selected in Step S811, and returns the processing to Step S812 (S814).

In a case where the determination of Step S813 is affirmative (S813: YES), the ST apparatus 10 determines whether nor not the primary virtual VOL and the secondary virtual VOL are able to form the RCP pair (S820). That is, the ST apparatus 10 compares the virtual VOL configuration information 211 and the logical VOL information 221 of the primary virtual VOL to the virtual VOL configuration information 211 and the logical VOL information 221 of the secondary virtual VOL included in the response from the destination ST apparatus 10, and determines whether or not RCP pair formation is possible. In a case where the determination in the relevant Step S820 is negative (S820: NO), the ST apparatus 10 responds to the host 14 to the effect that RCP pair formation is not possible and ends the relevant processing.

In a case where the determination in Step S820 is affirmative (S820: YES), the ST apparatus 10 registers the virtual VOL configuration information 211 and the logical VOL information 221 of the secondary virtual VOL, which was acquired in accordance with the response to the “request virtual VOL configuration information” command, in the pair management information table 230 and the pair logical VOL information table 240. In addition, the ST apparatus 10 acquires path information for communicating with each ST apparatus 10 comprising the secondary virtual VOL from the virtual apparatus information table 310, the ST apparatus information table 320, and the communication path information table 330 and registers this information in the pair path information 141 (S821).

The numerous examples described above are examples for illustrating the present invention, and do not purport to limit the scope of the present invention solely to these examples. A person with ordinary skill in the art will be able to put the present invention into practice using various other modes without departing from the gist of the present invention.

### REFERENCE SIGNS LIST

10 ST apparatus
12 Virtual VOL
14 Host
20 Logical VOL
200 Virtual VOL mapping information table
210 Virtual VOL configuration information table
220 Logical VOL information table
230 Pair management information table
240 Pair logical VOL information table

1. A storage system, comprising:
multiple primary storage apparatuses each comprising multiple primary logical volumes, which constitute the basis of a primary virtual volume; and
multiple secondary storage apparatuses each comprising multiple secondary logical volumes, which constitute the basis of a secondary virtual volume forming a remote copy pair with the primary virtual volume,
wherein A) the primary storage apparatus remote-copies data written in a primary logical volume of the relevant primary storage apparatus to a secondary logical volume of any secondary storage apparatus of the multiple secondary storage apparatuses corresponding to a write destination of the data.

2. A storage system according to claim 1, wherein
the primary virtual volume comprises multiple primary virtual areas, the secondary virtual volume comprises multiple secondary virtual areas, the number of secondary virtual areas comprising the secondary virtual volume is the same as the number of primary virtual areas comprising the primary virtual volume, and a capacity of each secondary virtual area is the same as a capacity of each primary virtual area,
the primary logical volume comprises multiple primary logical areas, and the secondary logical volume comprises multiple secondary logical areas,
the capacity of at least one primary logical volume differs from the capacity of at least one secondary logical volume,
a first primary storage apparatus, which is one of the multiple primary storage apparatuses, comprises remote copy pair management information,
the remote copy pair management information denotes an association between a prescribed primary logical area of the primary logical volume and a prescribed secondary logical area of the secondary logical volume, and
B) in the A), the first primary storage apparatus identifies on the basis of remote copy pair management information a secondary logical area corresponding to a primary logical area into which data has been written, and remote-copies this written data to the secondary storage apparatus comprising this identified secondary logical area.

3. A storage system according to claim 2, wherein
the first primary storage apparatus comprises logical volume management information,
the logical volume management information denotes the association between a prescribed primary virtual area of the primary virtual volume and a prescribed primary logical area of any primary logical volume, the first primary storage apparatus, based on the logical volume management information, C) identifies a primary logical area corresponding to a primary virtual area, which includes a write destination specified in a write request with respect to write-target data, and in a case where this identified the primary logical area exists in a first primary logical volume of the relevant first primary storage apparatus, executes the B), and in a case where this identified the primary logical area exists in a second primary logical volume of another second primary storage apparatus, transfers the write-target data to the relevant second primary storage apparatus.

4. A storage system according to claim 3, wherein
the first primary storage apparatus, in a case where in the C) the write-destination primary logical area of a portion of the write-target data exists in a primary logical volume of the relevant first primary storage apparatus and the write-destination primary logical area of the remainder of the write-target data exists in the second primary logical volume of the second primary storage apparatus, executes the B) with respect to the portion of the write-target data and transfers the remainder of the write-target data to the second primary logical volume.

5. A storage system according to claim 4, wherein
the first primary storage apparatus, in a case where a first prescribed process request has been received subsequent to transferring the remainder of the write-target data to the second primary logical volume, sends a write-suspend command to all of the primary storage apparatuses forming the primary virtual volume and including the second primary storage apparatus, and, in addition, transitions to a write-suspend state in which writing to a primary logical volume is temporarily suspended,
the primary storage apparatuses, which receive the write-suspend command, transition to the write-suspend state and send to the first primary storage apparatus a completion notification, which is a notification of the transition to the write-suspend state,
the second primary storage apparatus, in a case where the write-suspend command has been received when the remainder of the write-target data has yet to be written to the second primary logical volume, writes the unwritten data to the second primary logical volume, and thereafter transitions to the write-suspend state,
the first primary storage apparatus, in a case where the relevant first primary storage apparatus is in the write-suspend state, and, in addition, has received the completion notifications from all of the write-suspend-command-destination primary storage apparatuses, sends a processing command for a second prescribed process for realizing the first prescribed process to all the primary storage apparatuses comprising the primary virtual volume, and, in addition, performs the second prescribed process,
the primary storage apparatuses, which have received the processing command, perform the second prescribed process in accordance with the processing command and send to the first primary storage apparatus a process completion notification, which is a notification that the second prescribed process has been completed,
the first primary storage apparatus, in a case where the relevant first primary storage apparatus has completed the second prescribed process, and, in addition, has received the process completion notification from all the processing-command-destination primary storage apparatuses, sends a command for cancelling the write-suspend state to all the primary storage apparatuses comprising the primary virtual volume, and, in addition, cancels the write-suspend state of the first primary storage apparatus, and
the primary storage apparatuses, which have received the cancel command, cancel the write-suspend state of the relevant primary storage apparatus and send to the first primary storage apparatus a cancellation notification, which is a notification that the write-suspend state has been cancelled.

6. A storage system according to claim 5, wherein
each primary storage apparatus, which is in the write-suspend state, even upon receiving data, does not write this data to a primary logical volume comprising the primary virtual volume, and
each of the primary storage apparatuses, when there is data for which a write was suspended, writes this data to the primary logical volume, which is the write-destination, in a case where the write-suspend state has been cancelled.

7. A storage system according to claim 6, wherein
the first prescribed process is a process for canceling a remote copy pair between the primary virtual volume and the secondary virtual volume, and
the second prescribed process is a process for changing the respective primary storage apparatuses, which comprise the primary virtual volume, and the respective secondary storage apparatuses, which comprise the secondary virtual volume, to a mode in which a remote copy is not executed.

8. A storage system according to claim 7, wherein
a primary storage apparatus and a secondary storage apparatus each comprises communication channel information,
the communication channel information denotes a communication channel, which links a primary storage apparatus to a secondary storage apparatus, as well as a communication channel, which links either establishes a link either between primary storage apparatuses or between secondary storage apparatuses, and
a primary storage apparatus, in a case where a remote copy of data to a secondary storage apparatus via a prescribed communication channel failed in the A), remote copies the data via a different communication channel from the prescribed communication channel on the basis of the communication channel information.

9. A storage system according to claim 1, wherein
in a case where a prescribed process is to be executed in the storage system, subsequent to the configuration of a write-suspend state, which temporarily suspends the writing of data to a primary logical volume for all the primary storage apparatuses comprising the primary virtual volume, each primary storage apparatus:
executes a process for the prescribed process; and
cancels the write-suspend state setting after the relevant process has been completed.

10. A storage system according to claim 9, wherein
the prescribed process is a process for canceling a remote copy pair between the primary virtual volume and the secondary virtual volume, and
the process for the prescribed process is a process for changing the respective primary storage apparatuses, which comprise the primary virtual volume, and the respective secondary storage apparatuses, which comprise the secondary virtual volume, to a mode in which a remote copy is not executed.

11. A storage system according to claim 9, wherein, when there is data for which a write has been temporarily suspended, the respective primary storage apparatuses write this data to the primary logical volume, which is the write destination, subsequent to cancelling the write-suspend state setting.

12. A storage system according to claim 1, wherein
a primary storage apparatus and a secondary storage apparatus each comprises communication channel information,
the communication channel information denotes a communication channel, which links a primary storage apparatus to a secondary storage apparatus, as well as a communication channel, which establish a link either between primary storage apparatuses or between secondary storage apparatuses, and
a primary storage apparatus, in a case where a remote copy of data to a secondary storage apparatus via a prescribed communication channel failed in the A), remote-copies the data via a different communication channel from the prescribed communication channel on the basis of the communication channel information.

13. A storage virtualization method comprising:
multiple primary storage apparatuses each comprising multiple primary logical volumes, which constitute the basis of a primary virtual volume; and
multiple secondary storage apparatus each comprising multiple secondary logical volumes, which constitute the basis of a secondary virtual volume forming a remote copy pair with the primary virtual volume,
the storage virtualization method comprising a step of:
the primary storage apparatus remote-copying data written in a primary logical volume of the relevant primary storage apparatus to a secondary logical volume of any secondary storage apparatus of the multiple secondary storage apparatuses corresponding to the write destination of this data.
